(19) United States
(12) Patent Application Publication
(10) Pub. No.: US 2024/0251388 A1
(43) Pub. Date: Jul. 25, 2024

(54) LONG RANGE TRANSMISSION MESH NETWORK

(71) Applicant: WEAVIX, INC., Wichita, KS (US)

(72) Inventors: Kevin TURPIN, Wichita, KS (US); Benjamin BURRUS, Wichita, KS (US)

(21) Appl. No.: 18/420,590

(22) Filed: Jan. 23, 2024

Related U.S. Application Data
(60) Provisional application No. 63/481,516, filed on Jan. 25, 2023.

(51) Int. Cl. H04W 72/04; H04W 72/51

(52) U.S. Cl. CPC H04W 72/04; H04W 72/51; H04W 84/18

(57) ABSTRACT

Methods, apparatuses, and systems for a long range transmission mesh network. Wireless devices operate as nodes on a mesh network. The wireless devices are configured to receive a downsampled transmission, process header information from the transmission, and broadcast the transmission to other nodes on the mesh network. Based on the approximate range of nearby nodes on the mesh network, the wireless devices automatically shift frequency bands. The wireless devices are configured to include a long range (LoRa) chip set, but not a LoRa wide area network (LoRaWAN) protocol.

### CROSS-REFERENCE TO RELATED APPLICATIONS

This application claims the benefit of U.S. Provisional Patent Application No. 63/481,516, entitled “GENERAL MOBILE OR FAMILY RADIO SERVICE BACKHAUL”, filed Jan. 25, 2023, which is incorporated by reference herein in its entirety.

### TECHNICAL FIELD

The present disclosure is generally related to wireless communication handsets and systems.

### BACKGROUND

The industrial, scientific, and medical (ISM) radio bands are portions of the radio spectrum that do not require a government license and that use channels around 902 MHz and 928 MHz. The ISM radio bands have commonly been used to support short-range, low-power wireless communication systems such as hand-held radios, mobile radios and repeater systems. Frontline workers are typically disallowed from carrying smartphones, tablets, or portable computers on site. When there is an emergency, a worker may need to alert others. However, traditional methods and systems for communication within, and monitoring of, manufacturing and construction facilities sometimes have inadequate risk management and safeguards, lack an efficient structure, or can suffer from unrealistic risk management expectations or poor production forecasting.

### BRIEF DESCRIPTION OF THE DRAWINGS

FIG. 1 is a block diagram illustrating an example architecture for an apparatus implementing device tracking using geofencing, in accordance with one or more embodiments.

FIG. 2A is a drawing illustrating an example environment for apparatuses and communication networks for device tracking and geofencing, in accordance with one or more embodiments.

FIG. 2B is a flow diagram illustrating an example process for generating a work experience profile using apparatuses and communication networks for device tracking and geofencing, in accordance with one or more embodiments.

FIG. 3 is a drawing illustrating an example facility using apparatuses and communication networks for device tracking and geofencing, in accordance with one or more embodiments.

FIG. 4 is a drawing illustrating example apparatuses for device tracking and geofencing, in accordance with one or more embodiments.

FIG. 5 is a drawing illustrating example apparatuses for device tracking and geofencing, in accordance with one or more embodiments.

FIG. 6 is a drawing illustrating the use of a backhaul in accordance with one or more embodiments.

FIG. 7 is a flow diagram illustrating the use of a backhaul in accordance with one or more embodiments.

FIG. 8 is a block diagram illustrating an example long range transmission mesh network, in accordance with one or more embodiments.

FIG. 9 is a diagram illustrating geofencing and geofenced-based communication within a facility or worksite, in accordance with one or more embodiments.

FIG. 10 is a flow diagram illustrating an example process for response-controlled communications for geofenced areas, in accordance with one or more embodiments.

FIG. 11 is a flow diagram illustrating an example process for classifying worker activity based on smart radio locations with role-specific activity areas, in accordance with one or more embodiments.

FIG. 12 is a drawing illustrating an example user interface for visualizing worker activity data, in accordance with one or more embodiments.

FIG. 13 is a flowchart illustrating automatic roaming of channels.

FIG. 14 is a block diagram illustrating an example machine learning (ML) system, in accordance with one or more embodiments.

FIG. 15 is a block diagram illustrating an example computer system, in accordance with one or more embodiments.

### DETAILED DESCRIPTION

The disclosed technology relates to a long range transmission mesh network. The technology includes smart radios employed in a mesh network using downsampled audio transmissions transmitted via industrial, scientific, and medical radio (ISM) bands. Once received, the audio is upsampled using digital software and transmitted via higher frequency radio bands based on the approximate range of nearby mesh devices. In some embodiments the mesh devices make use of a long range (LoRa) chip set, but not the LoRa wide area network (LoRaWAN) protocol. In some embodiments, the technology includes the use of encoded data transmitted over a metadata radio channel as a backhaul that uses audio codec to instruct devices to move to a given channel in order to communicate.

Analytics are applied to return-to-work calls after lightning/fire/chemical alerts. The analytics features are applied specifically to return-to-work calls that occur after suspension of work. Workers of each contractor have a measured average time to return to the location they were working. Additional technology includes determining a proximity to equipment via Bluetooth low energy (BLE) tag logs use of equipment time. Thresholds on a per equipment or an equipment class basis identify an intro distance, a break distance, and dwell time. A given user is “using” equipment once they have come at least as close as the intro distance and remained for a threshold dwell time (avoids passing by use). The user stops using the equipment after exceeding a break distance for a threshold time. Additional features include image viewing and camera operation disabled by certain locations, location tracking on form completion, and automated muster locations plus BLE tags for guests.

The embodiments disclosed herein describe methods, apparatuses, and systems for device tracking and geofencing. Construction, manufacturing, repair, utility, resource extraction and generation, and healthcare industries, among others, rely on real-time monitoring and tracking of frontline workers, individuals, inventory, and assets such as infrastructure and equipment. In some embodiments, a portable and/or wearable apparatus, such as a smart radio, a smart camera, or a smart environmental sensor that records information, downloads information, communicates with other apparatuses or a cellphone tower, and detects gas levels, or temperature is used by frontline workers to provide compliance, quality, or safety. Some embodiments of the present disclosure provide lightweight and low-power apparatuses that are worn or carried by a worker and used to monitor information in the field, or track the worker for logistical purposes. The disclosed apparatuses provide alerts, locate resources for workers, and provide workers with access to communication networks. The wearable apparatuses disclosed enable worker compliance and provide assistance with operator tasks.

The advantages and benefits of the methods, systems, and apparatuses disclosed herein include solutions for overcoming offline channel limitations, solving network coverage issues for remote areas, and reducing latency for onsite communications. Further advantages and benefits include solutions for confined-space management using live video feeds, gas detection, and analysis of entry and exit times for personnel using smart devices. The disclosed systems enable the provision of video collaboration software for the industrial field using streamlined enterprise-grade video with interactive meeting capabilities. Workers join from the field on their apparatuses without relying on software integrations or the purchase of additional software. Some embodiments disclosed enable workers to view other workers' credentials and roles such that participants know the level of expertise present. The systems further enable the location of workers who are currently out in the field using a facility map that is populated by information from smart radios, smart cameras, or smart sensors.

Among other benefits and advantages, the disclosed systems provide greater visibility compared to traditional methods within a confined space of a facility for greater workforce optimization. The digital time logs for entering and exiting a facility measure productivity levels on an individual basis and provide insights into how the weather at outdoor facilities in different geographical locations affects workers. The time tracking technology enables visualization of the conditions a frontline worker is working under while keeping the workforce productive and protected. In addition, the advantages of the machine learning (ML) modules in the disclosed systems include the use of shared weights in convolutional layers, which means that the same filter (weights bank) is used for each node in a layer. The weight structure both reduces memory footprint and improves performance for the system.

The smart radio embodiments disclosed that include Radio over Internet Protocol (RoIP) provide the ability to use an existing Land Mobile Radio (LMR) system for communication between workers, allowing a company to bridge the gap that occurs through the process of digitally transforming their systems. Communication is thus more open because legacy systems and modern apparatuses communicate with fewer barriers, the communication range is not limited by the radio infrastructure because the smart radios use the Internet, and costs are reduced for a company to provide communication apparatuses to their workforce by obviating more-expensive, legacy radios. The smart apparatuses enable workers to provide field observations to report safety issues in real-time to mitigate risk, prevent hazards, and reduce time barriers to drive operational performance. Workers in the field use the smart apparatuses to more-quickly notify management of potential safety issues or issues that are causing delays. The apparatuses enable mass notifications to rapidly relay information to a specific subgroup, provide real-time updates for evacuation, and transmit accurate location pins.

The smart apparatuses disclosed reduce the need for workers to wear multiple, cumbersome, non-integrated, and potentially distractive devices into one user-friendly, comfortable, and cost-effective smart device. Advantages of the smart radio disclosed include ease of use for carrying in the field during extended durations due to its smaller size, relatively low power consumption, and integrated power source. The smart radio is sized to be small and lightweight enough to be regularly worn by a worker. The modular design of the smart radio disclosed enables quick repair, refurbishment, or replacement. The apparatuses are shared between workers on different shifts to control inventory as needed. The smart apparatuses only work inside a facility geofence, reducing the impulse to steal.

Embodiments of the present disclosure will be described more thoroughly from now on with reference to the accompanying drawings. Like numerals represent like elements throughout the several figures, and in which example embodiments are shown. However, embodiments of the examples are embodied in many different forms and should not be construed as limited to the embodiments set forth herein. The examples set forth herein are non-limiting examples and are merely examples, among other possible examples. Throughout this specification, plural instances (e.g., “224”) implement components, operations, or structures (e.g., “224a”) described as a single instance. Further, plural instances (e.g., “224”) refer collectively to a set of components, operations, or structures (e.g., “224a”) described as a single instance. The description of a single component (e.g., “224a”) applies equally to a like-numbered component (e.g., “224b”) unless indicated otherwise. These and other aspects, features, and implementations are expressed as methods, apparatuses, systems, components, program products, means, or steps for performing a function, and in other ways. These and other aspects, features, and implementations will become apparent from the following sections, including the examples. Any of the embodiments described in each section can be used with one another and features of each embodiment are not necessarily exclusive to the described embodiment such that the headings are not limiting.

### Smart Radio

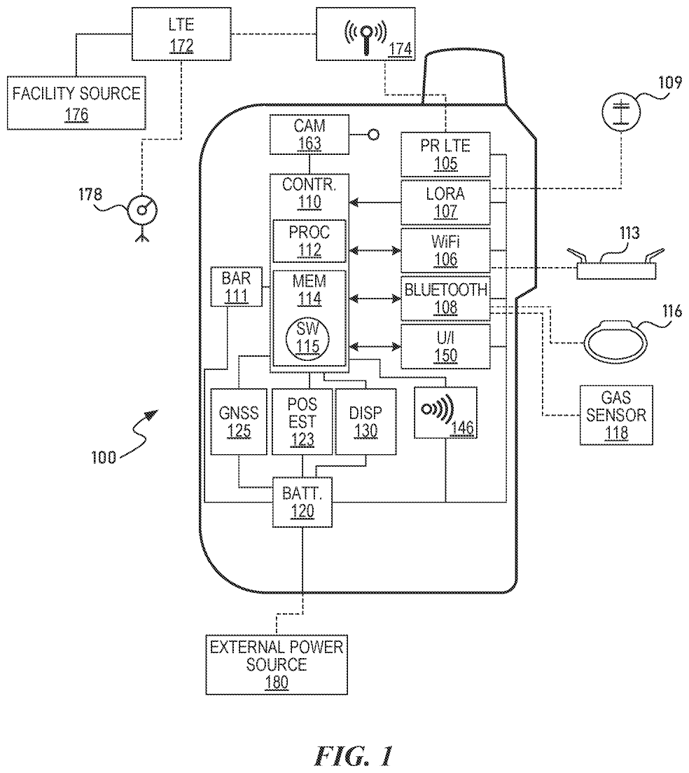

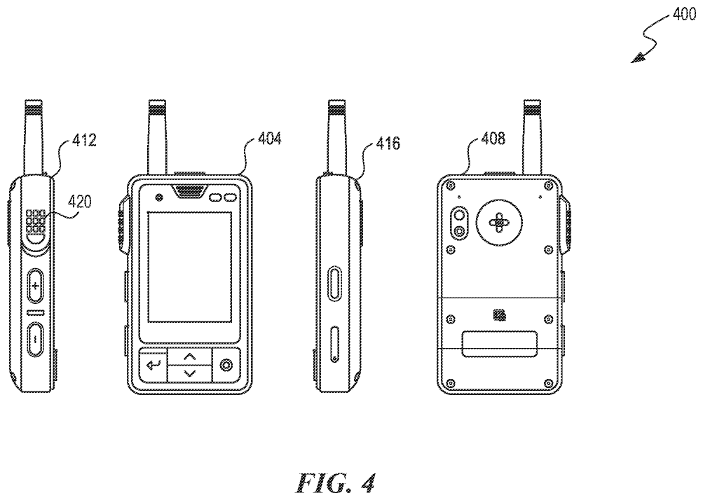

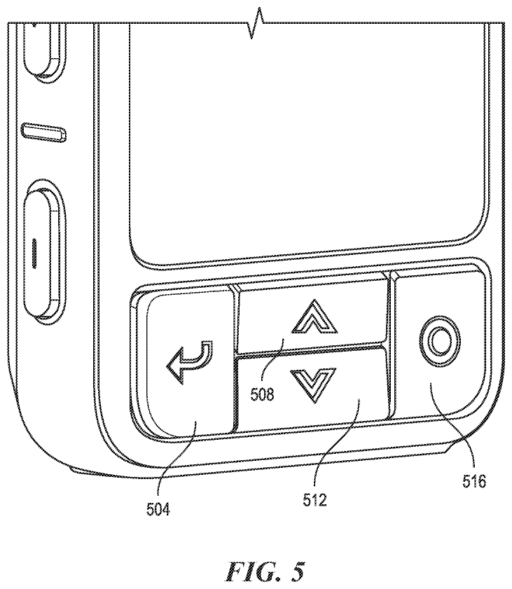

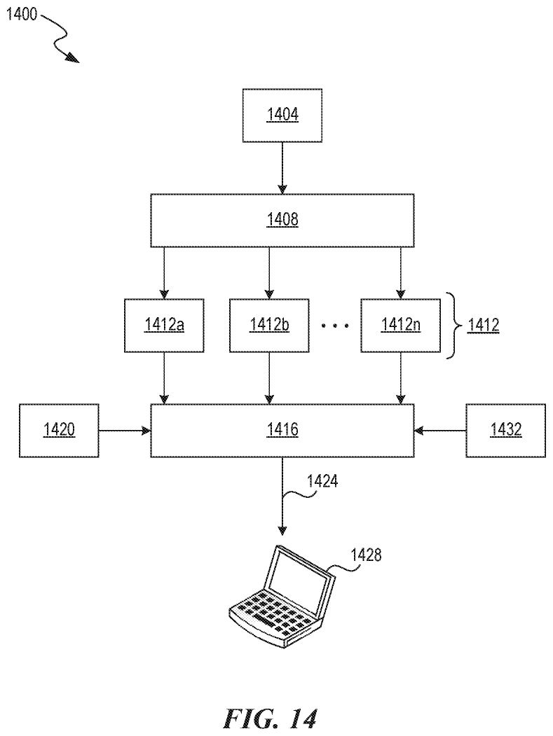

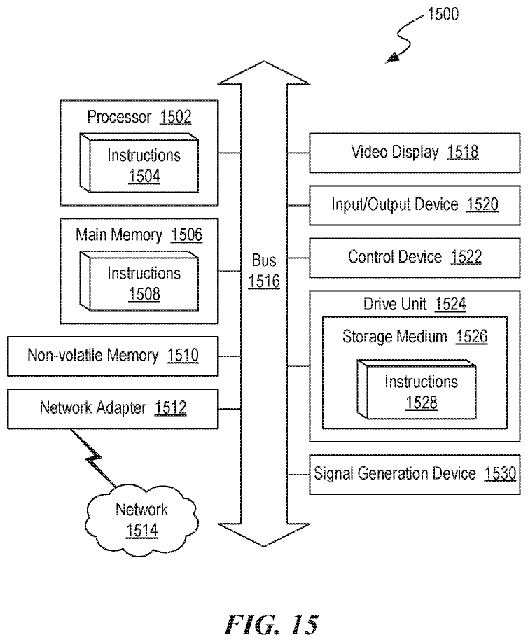

FIG. 1 is a block diagram illustrating an example architecture for an apparatus 100 implementing device tracking using geofencing, in accordance with one or more embodiments. The apparatus 100 is implemented using components of the example computer system 1500 illustrated and described in more detail with reference to FIG. 15. In embodiments, the apparatus 100 is used to execute the machine learning (ML) system 1400 illustrated and described in more detail with reference to FIG. 14. The architecture shown by FIG. 1 is incorporated into a portable wireless apparatus 100, such as a smart radio, a smart camera, a smart watch, a smart headset, or a smart sensor. FIGS. 4-5 show different views of an exemplary smart radio that includes the architecture of the apparatus 100 shown in FIG. 1. Likewise, different embodiments of the apparatus 100 include different and/or additional components and are connected in different ways.

The apparatus 100 shown in FIG. 1 includes a controller 110 communicatively coupled electronically either directly or indirectly to a variety of wireless communication arrangements, a position estimating component 123 (e.g., a dead-reckoning system), which estimates current position using inertia, speed, and intermittent known positions received from a position tracking component 125, which in embodiments, is a Global Navigation Satellite System (GNSS) component, a display screen 130, an optional audio device 140, a user-input device 150, and a dual built-in camera 165 (another camera, 160, is on the other side of the device). A battery 120 is electrically coupled with a private Long-Term Evolution (LTE) wireless communication device 105, a Wi-Fi subsystem 106, a low-power wide area network (LPWAN), for example, long range (LoRa) protocol subsystem 107, Bluetooth subsystem 108, barometer 111, audio device 140, user-input device 150, and built-in camera 160 for providing electrical power. Battery 120 is electrically and communicatively coupled with controller 110 for providing electrical power to controller 110 and enabling controller 110 to determine a status of battery 120 (e.g., a state-of-charge). In embodiments, battery 120 is a removable rechargeable battery.

Controller 110 is, for example, a computer having a memory 114, including a non-transitory storage medium for storing software 115, and a processor 112 for executing instructions of the software 115. In some embodiments, controller 110 is a microcontroller, a microprocessor, an integrated circuit (IC), or a system-on-a-chip (SoC). Controller 110 includes at least one clock capable of providing time stamps and displaying time via display screen 130. The at least one clock is updatable (e.g., via the user interface 150, a global positioning system (GPS) navigational device, the position tracking component 125, the Internet 106, a private cellular network 107 subsystem, the server 170, or a combination thereof).

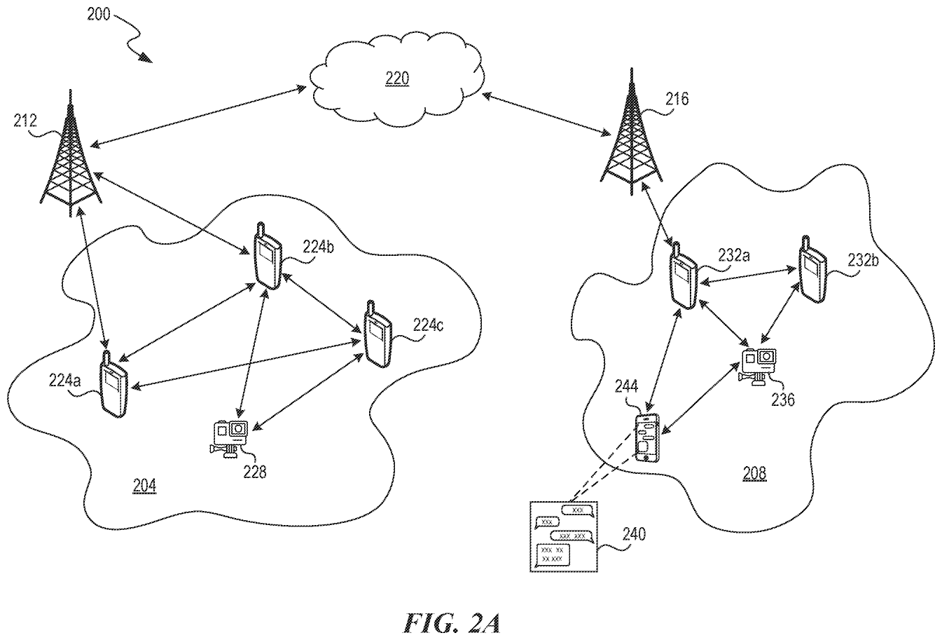

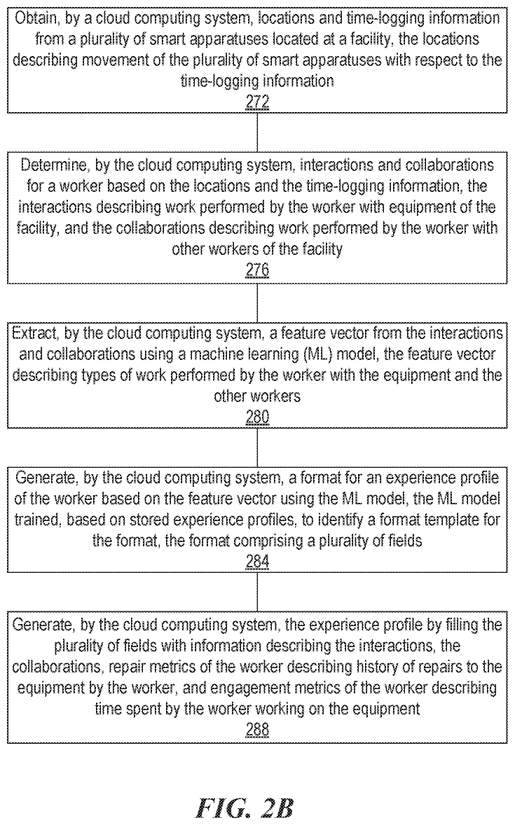

The cloud computing system 220 stores, manages, and updates shifts, contacts, and roles for each worker, project, and facility. A shift refers to a planned set period of time during which the worker (optionally with a group of other workers) performs their duties. The workday is divided into shifts. A worker is assigned one or more shifts (e.g., 9:00 a.m.-5:00 p.m. on Monday and Wednesday) to work and the assignments are stored, managed, and updated by the cloud computing system 220 based in part on time logging information received from the smart radios and other smart apparatuses (as shown by FIG. 2A). The worker has one or more roles (e.g., lathe operator, lift supervisor) for the same or different shifts. For each role and shift, the worker has one or more contacts (e.g., emergency contact(s), supervisory contact(s), etc.) assigned to the worker. The contacts are stored, managed, and updated by the cloud computing system 220 based in part on time logging information received from the smart radios. For example, the information reflects that the 9:00 a.m.-5:00 p.m. Monday shift has concluded, and the contacts are updated for the next shift of the worker.

In an example, a worker, Alice, begins their shift using a particular smart radio. After Alice picks up the smart radio and clocks in, Alice is introduced to Bob, her emergency contact. Alice can further access the name and contact information for the emergency contact, Bob, assigned to Alice for that shift using the smart radio. Three hours later, Bob's shift ends and Bob clocks out. A next shift (Chuck's shift) begins, however, Alice is still working on their shift. Chuck is Alice's new emergency contact. Alice is not necessarily aware of the change. However, the smart radio that Alice is using will automatically reflect that the emergency contact is now Chuck. The cloud computing system 220 thus stores, manages, and updates shifts, contacts, and roles for each worker, project, and facility. The information is updated based in part on time logging information received from the smart radios and other smart apparatuses (as shown by FIG. 2A). The cloud computing system 220 updates each smart radio with the information (on roles and contacts) needed for a shift when a worker clocks in using the radio.

In some embodiments, roles are assigned on a tiered basis. For example, Alice has roles assigned to her as an individual, as connected to the contract she is working, and as connected to her employer. Each of those tiers operates identity management within the cloud computing system 220. Each user frequently will work with others they have never met before and do not have the contact information thereto. Frontline workers tend to collaborate across employers or contracts. Based on tiered assigned roles, the relevant contact information for workers on a given task/job is shared therebetween. “Contact information” as facilitated by the smart radio is governed by the user account in each smart radio (e.g., as opposed to a phone number connected to a cellular phone).

In another example, Alice begins their shift using a particular smart radio. After Alice picks up the smart radio and clocks in, Alice can access the name and contact information for the emergency contact, Bob, assigned to Alice for that shift using the smart radio. Three hours later, when the shift ends and Alice clocks out, a next shift (Chuck's shift) begins. Chuck picks up the same (or a different) smart radio to clock in for their shift. If Chuck is using the same smart radio that Alice just used, the smart radio will automatically reflect that the emergency contact is now the emergency contact (Darla) assigned to Chuck for the next shift. After Chuck picks up the smart radio and clocks in, Chuck can access the name and contact information for the emergency contact, Darla, assigned to Chuck for the next shift using the smart radio. If Chuck is using a different smart radio from the radio that Alice used, the different smart radio will also automatically reflect that the emergency contact is now the emergency contact (Darla) assigned to Chuck for the next shift. The cloud computing system 220 thus stores, manages, and updates shifts, contacts, and roles for each worker, project, and facility. The information is updated based in part on time logging information received from the smart radios and other smart apparatuses (as shown by FIG. 2A). The cloud computing system 220 updates each smart radio with the information (on roles and contacts) needed for a shift when a worker clocks in using the radio.

In embodiments, a front-facing camera of the smart radio is used to capture employee clock-ins to deter “buddy clocking” or “buddy punching,” whereby one worker fraudulently records the time of another. For example, the smart radio or cloud computing system 220 operates a facial recognition system (e.g., using the ML system 1400 illustrated and described in more detail with reference to FIG. 14), eliminating the need of a fingerprint scanner. Cloud-based software running on the smart radio enables the time logging mechanism to work seamlessly with the cloud computing system 220. In embodiments, Human Resources (HR) software is used for tracking employee time, and can, in versions, interact with smart radios or other devices to track and record when a worker enters a particular facility, or portion of a facility, and at what time each entry occurs. In order to gain access to a particular protected area of a facility, a worker uses NFC functionality of the smart radio to scan an NFC device located at an entry point, is allowed access, and the HR application records the time access was granted. The smart radios can also be used to scan NFC tags or cards mounted at locations (e.g., vessels and equipment). In embodiments, the machine learning system 1400, illustrated and described in more detail with reference to FIG. 14, is used to detect and track abnormalities in time logging, for example, using features based on the number of workers clocking in or facility slowdowns as input data.

In embodiments, the smart radio and the cloud computing system 220 have geofencing capabilities. The smart radio allows the worker to clock in and out only when they are within a particular Internet geolocation. A geofence refers to a virtual perimeter for a real-world geographic area, (e.g., a portion of a facility). For example, a geofence is dynamically generated for the facility (as in a radius around a point location) or matched to a predefined set of boundaries (such as construction zones or refinery boundaries, or around specific equipment). A location-aware device (e.g., the position tracking component 125 and the position estimating component 123) of the smart radio entering or exiting a geofence triggers an alert to the smart radio, as well as messaging to a supervisor's device (e.g., the text messaging display 240 illustrated in FIG. 2A), the cloud computing system 220 or a local server. The information, including a location and time is sent to the cloud computing system 220. In embodiments, the machine learning system 1400, illustrated and described in more detail with reference to FIG. 14, is used to trigger alerts, for example, using features based on equipment malfunctions or operational hazards as input data.

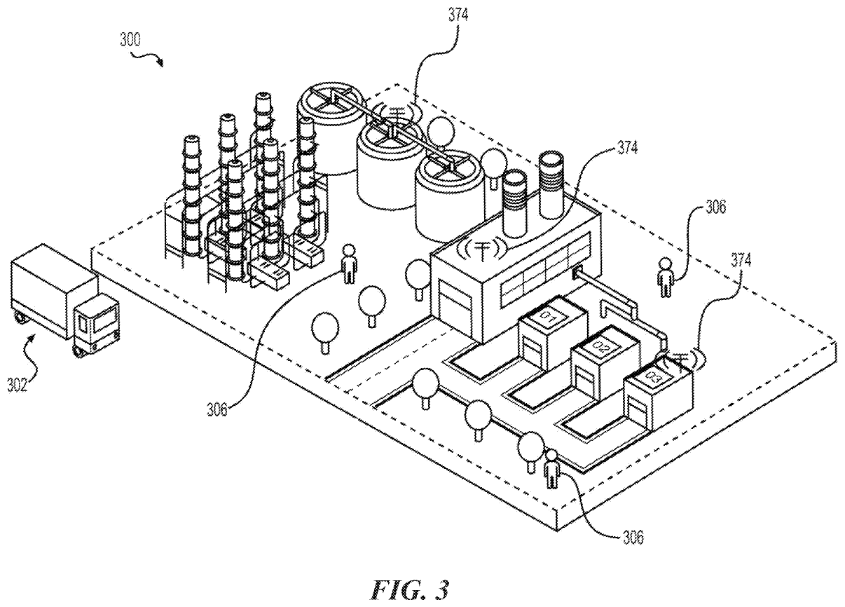

The wireless communications arrangement includes a cellular subsystem 105, a Wi-Fi subsystem 106, the optional LPWAN/LoRa network subsystem 107 wirelessly connected to a LPWAN network 109, and a Bluetooth subsystem 108, all enabling sending and receiving. Cellular subsystem 105, in embodiments, enables the apparatus 100 to communicate with at least one wireless antenna 174 located at a facility (e.g., a manufacturing facility, a refinery, or a construction site). For example, the wireless antennas 174 are permanently installed or temporarily deployed at the facility. Example wireless antennas 374 are illustrated and described in more detail with reference to FIG. 3.

In embodiments, a cellular edge router arrangement 172 is provided for implementing a common wireless source. A cellular edge router arrangement 172 (sometimes referred to as an “edge kit”) is usable to include a wireless cellular network into the Internet. In embodiments, the LPWAN network 109, the wireless cellular network, or a local radio network is implemented as a local network for the facility usable by instances of the apparatus 100, for example, the local network 204 illustrated and described in more detail with reference to FIGS. 2A and 2B. For example, the cellular type can be 2G, 3G, 4G, LTE, 5G, etc. The edge kit 172 is typically located near a facility's primary Internet source 176 (e.g., a fiber backhaul or other similar device). Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle, or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHz). For example, the apparatus 100 can operate using a duplex mode implemented using time division duplexing (TDD) or frequency division duplexing (FDD).

A Wi-Fi subsystem 106 enables the apparatus 100 to communicate with an access point 114 capable of transmitting and receiving data wirelessly in a relatively high-frequency band. In embodiments, the Wi-Fi subsystem 106 is also used in testing the apparatus 100 prior to deployment. A Bluetooth subsystem 108 enables the apparatus 100 to communicate with a variety of peripheral devices, including a biometric interface device 116 and a gas/chemical detection device 118 used to detect noxious gases. In embodiments, the biometric and gas-detection devices 116 and 118 are alternatively integrated into the apparatus 100. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the cloud/Internet for accessing websites, databases, etc. The wireless subsystems 105, 106, and 108 are each configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range.

In embodiments, multiple apparatuses 100 are connected to provide data connectivity and data sharing across the multiple apparatuses 100. In embodiments, the shared connectivity is used to establish a mesh network. In some embodiments, the multiple apparatuses are configured to use a LoRa chip set, but not a LoRa wide area network (LoRaWAN) protocol. In an illustrative example, Codec 2 protocol is employed with the LoRa chip set.

The position tracking component 125 and the position estimating component 123 operate in concert. In embodiments, the position tracking component 125 is a GNSS (e.g., GPS) navigational device that receives information from satellites and determines a geographical position based on the received information. The position tracking component 125 is used to track the location of the apparatus 100. In embodiments, a geographic position is determined at regular intervals (e.g., every five seconds) and the position in between readings is estimated using the position estimating component 123.

GPS position data is stored in memory 114 and uploaded to server 170 at regular intervals (e.g., every minute). In embodiments, the intervals for recording and uploading GPS data are configurable. For example, if the apparatus 100 is stationary for a predetermined duration, the intervals are ignored or extended, and new location information is not stored or uploaded. If no connectivity exists for wirelessly communicating with server 170, location data is stored in memory 114 until connectivity is restored, at which time the data is uploaded, then deleted from memory 114. In embodiments, GPS data is used to determine latitude, longitude, altitude, speed, heading, and Greenwich mean time (GMT), for example, based on instructions of software 115 or based on external software (e.g., in connection with server 170). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, Bluetooth component 108 receives signals from Bluetooth Low Energy (BLE) beacons. The BLE beacons are located about the facility similar to the example wireless antennas 374 shown by FIG. 3. The controller 110 is programmed to execute relational distancing software using beacon signals (e.g., triangulating between beacon distance information) to determine the position of the apparatus 100. Regardless of the process, the Bluetooth component 108 detects the beacon signals and the controller 110 determines the distances used in estimating the location of the apparatus 100.

In alternative embodiments, the apparatus 100 uses Ultra-Wideband (UWB) technology with spaced apart beacons for position tracking and estimation. The beacons are small battery powered sensors that are spaced apart in the facility, and broadcast signals received by a UWB component included in the apparatus 100. A worker's position is monitored throughout the facility over time when the worker is carrying or wearing the apparatus 100. As described herein, location sensing GNSS and estimating systems (e.g., the position tracking component 125 and the position estimating component 123) can be used to primarily determine a horizontal location. In embodiments, the barometer component is used to determine a height that the apparatus 100 is located at (or operate in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

An external power source 180 is optionally provided for recharging battery 120. The battery 120, in embodiments, is shaped, sized, and electrically configured to be receivable into a charging station (not shown by FIG. 1).

In embodiments, display screen 130 is a touch screen implemented using a liquid-crystal display (LCD), an e-ink display, an organic light-emitting diode (OLED), or other digital display capable of displaying text and images. An example text messaging display 240 is illustrated in FIG. 2A. In embodiments, display screen 130 uses a low-power display technology, such as an e-ink display, for reduced power consumption. Images displayed using display screen 130 include but are not limited to photographs, video, text, icons, symbols, flow charts, instructions, cues, and warnings. For example, display screen 130 displays (e.g., by default) an identification style photograph of an employee who is carrying the apparatus 100 such that the apparatus 100 replaces a traditional badge worn by the employee. In another example, step-by-step instructions for aiding a worker while performing a task are displayed via display screen 130. In embodiments, display screen 130 locks after a predetermined duration of inactivity by a worker to prevent accidental activation via user-input device 150.

The audio device 146 optionally includes at least one microphone (not shown) and a speaker for receiving and transmitting audible sounds, respectively. Although only one speaker is shown existing in the architecture drawing of FIG. 1, it should be understood that in an actual physical embodiment, multiple speakers (and also microphones used for the purpose of noise cancellation) are utilized such that the apparatus 100 can adequately receive and transmit audio. In embodiments, the speaker has an output around 105 dB to be loud enough to be heard by a worker in a noisy facility. The speaker adjusts to ambient noise, for example, the audio device 146 or a circuit driving the speaker samples the ambient noise, and then increases a volume of the output audio from the speaker such that the volume is greater than the ambient noise (e.g., 5 dB louder). In embodiments, a worker speaks commands to the apparatus 100. The microphone of the audio device 146 receives the spoken sounds and transmits signals representative of the sounds to controller 110 for processing. In embodiments, the machine learning system 1400, illustrated and described in more detail with reference to FIG. 14, is used to generate appropriate volume levels, for example, using features based on noise at a location or manufacturing operation types as input data.

In embodiments, the audio device 146 disseminates audible information to the worker via the speaker and receives spoken sounds via the microphone(s). The audible information is generated by the apparatus 100 based on data or signals received by the apparatus 100 (e.g., the smart camera 228 illustrated and described in more detail with reference to FIGS. 2A and 2B) from the cloud computing system 220, an administrator, or a local server. For example, the audible information includes instructions, reminders, cues, and/or warnings to the worker and is in the form of speech, bells, dings, whistles, music, or other attention-grabbing noises without departing from the scope hereof. In embodiments, one or more speakers of the apparatus 100 (e.g., the smart radio illustrated in FIG. 4) are adapted to emit sounds from a front side 404, a back side 408, any of the other sides 412, 416 of the smart radio, or even multiple sides of the smart radio.

In embodiments, the apparatus 100 is continuously powered on. For example, an option to turn off the apparatus 100 is not available to a worker (e.g., an operator without administrator privileges). If the battery 120 discharges below a cut-off voltage, such that the apparatus 100 loses power and turns off, the apparatus 100 will automatically turn on upon recharging of battery 120 to above the cut-off voltage. In operation, the apparatus 100 enters a standby mode when not actively in use to conserve battery charge. Standby mode is determined via controller 110 to provide a low-power mode in which no data transmission occurs and display screen 130 is in an OFF state. In the standby mode, the apparatus 100 is powered on and ready to transmit and receive data. During use, the apparatus 100 operates in an operational mode. In embodiments, the display screen 130, upon activation, is configured to display a battery level (e.g., a state-of-charge) indication. The indicator is made to be presented due to processes running on controller 110 (e.g., which detect voltage from a voltmeter electrically coupled with battery 180 and electronically connected with the controller 110).

### Communication Network Features

FIG. 2A is a drawing illustrating an example environment 200 for apparatuses and communication networks for device tracking and geofencing, in accordance with one or more embodiments. The environment 200 includes a cloud computing system 220, cellular transmission towers 212, 216, and local networks 204, 208. Components of the environment 200 are implemented using components of the example computer system 1500 illustrated and described in more detail with reference to FIG. 15. Likewise, different embodiments of the apparatus 100 include different and/or additional components and are connected in different ways.

Smart radios 224, 232 and smart cameras 228, 236 are implemented in accordance with the architecture shown by FIG. 1. In embodiments, smart sensors implemented in accordance with the architecture shown by FIG. 1 are also connected to the local networks 204, 208 and mounted on a surface of a worksite, or worn or carried by workers. For example, the local network 204 is located at a first facility and the local network 208 is at a second facility. An example facility 300 is illustrated and described in more detail with reference to FIG. 3. In embodiments, each smart radio and other smart apparatus has two (Subscriber Identity Module) SIM cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 224a to connect to the local (e.g., cellular) network 204 and a second SIM card enables the smart radio 224a to connect to a commercial cellular tower (e.g., cellular tower 212) for access to mobile telephony, the Internet, and the cloud computing system 220 (e.g., to major participating networks such as Verizon™, AT&T™, T-Mobile™, or Sprint™). In such embodiments, the smart radio 224a has two radio transceivers, one for each SIM card. In other embodiments, the smart radio 224a has two active SIM cards, and the SIM cards both use only one radio transceiver. However, the two SIM cards are both active only as long as both are not in simultaneous use. As long as the SIM cards are both in standby mode, a voice call could be initiated on either. However, once the call begins, the other SIM becomes inactive until the first SIM card is no longer actively used.

In embodiments, the local network 204 uses a private address space of IP addresses. In other embodiments, the local network 204 is a local radio-based network using peer to peer two-way radio (duplex communication) with extended range based on hops (e.g., from smart radio 224a to smart radio 224b to smart radio 224c). Hence, radio communication is transferred similar to addressed packet-based data with packet switching by each smart radio or other smart apparatus on the path from source to destination. For example, each smart radio or other smart apparatus operates as a transmitter, receiver, or transceiver for the local network 204 to serve a facility. The smart apparatuses serve as multiple transmit/receive sites interconnected to achieve the range of coverage required by the facility. Further, the signals on the local networks 204, 208 are backhauled to a central switch for communication to the cellular towers 212, 216.

In embodiments (e.g., in more remote locations), the local network 204 is implemented by sending radio signals between smart radios 224. Such embodiments are implemented in less inhabited locations (e.g., wilderness) where workers are spread out over a larger work area. There may be otherwise inaccessible to commercial cellular service in such work areas. An example is where power company technicians are examining or otherwise working on power lines over larger distances that are often remote. The embodiments are implemented by transmitting radio signals from a smart radio 224a to other smart radios 224b, 224c on one or more frequency channels operating as a two-way radio. The radio messages sent include a header and a payload. Such broadcasting does not require a session or a connection between the devices. Data in the header is used by a receiving smart radio 224b to direct the “packet” to a destination (e.g., smart radio 224c). At the destination, the payload is extracted and played back by the smart radio 224c via the radio's speaker.

For example, the smart radio 224a broadcasts voice data using radio signals. Any other smart radio 224b within a range limit (e.g., 1 mile (mi), 2 mi, etc.) receives the radio signals. The radio data includes a header having the destination of the message (smart radio 224c). The radio message is decrypted/decoded and played back on only the destination smart radio 22c. If another smart radio 224b receives the radio signals that was not the destination radio, the smart radio 224b re-broadcasts the radio signals rather than decoding and playing them back on a speaker. The smart radios 224 are thus used as signal repeaters. The advantages and benefits of the embodiments disclosed herein include extending the range of two-way radios or smart radios 224 by implementing radio hopping between the radios.

In embodiments, the local network is implemented using Radio over Internet Protocol (RoIP). RoIP, is similar to Voice over IP (VoIP), but augments two-way radio communications rather than telephone calls. For example, RoIP is used to augment VoIP with PTT (Push-to-Talk). A smart radio having a PTT button on a user interface 420 is illustrated in FIG. 4. With RoIP, at least one node of a network is a radio (or a radio with an IP interface device, e.g., the smart radio 224a) connected via IP to other nodes (e.g., smart radios 224b, 224c) in the local network 204. The other nodes can be two-way radios but could also be softphone applications running on a smartphone (e.g., the smartphone 224, or some other communications device accessible over IP).

In embodiments the smart radios 224 operate as nodes on a mesh network. The smart radios 224 are configured with a first transceiver configured to communicate via wireless and machine to machine protocols in the 2.4-2.6 GHz band, and a second transceiver configured to include a LoRa chip set and a Codec 2 protocol in the 900 MHz band. The smart radios 224 are further configured to identify the approximate range of other nodes of the mesh network. For example, the smart radios 224 periodically send a range request signal (e.g., via a RSSI distance measurement or Bluetooth Low Energy (BLE) beacon signal) to nearby nodes to identify an approximate range. In other examples, the smart radios 224 triangulate an approximate position of other nodes on the mesh network by processing multiple range request signals. Based on the approximate range of nearby nodes, the smart radios 224 automatically shift between the frequency bands associated with the first transceiver and the frequency bands associated with the second transceiver when broadcasting a transmission. In embodiments, the smart radios 224 are configured to automatically broadcast in frequency bands associated with the second transceiver if the approximate range and position of nearby nodes is undetermined.

In embodiments, local network 204 is implemented using the Industrial, Scientific, and Medical (ISM) radio bands. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 204 is a private cellular (e.g., LTE) network operated specifically for the benefit of the facility. An example facility 300 implementing a private cellular network using wireless antennas 374 is illustrated and described in more detail with reference to FIG. 3. Only authorized users of the smart radios 224 have access to the local network 204. For example, the network 204 uses the 900 MHz band. In another example, the local network 204 uses 900 MHz for voice and narrowband data for land mobile radio (LMR) communications, 900 MHz broadband for critical wide area, long-range data communications, and the 2.4-2.6 GHz band for ultra-fast coverage of smaller areas of the facility, such as substations, storage yards and office spaces. In another example, Citizens Broadband Radio Service (CBRS) is used for ultra-fast coverage of smaller areas of the facility.

In alternative embodiments, the local network 204 is implemented using CBRS instead of the ISM radio bands. To enable CBRS, the controller 110 includes multiple computing and other devices, in addition to those depicted (e.g., multiple processing and memory components relating to signal handling, etc.). The controller 110 is illustrated and described in more detail with reference to FIG. 1. For example, the private network component 105 (illustrated and described in more detail with reference to FIG. 1) includes numerous components related to supporting cellular network connectivity (e.g., antenna arrangements and supporting processing equipment configured to enable CBRS). The use of CBRS Band 48 (from 3550 MHz to 3700 MHz), in embodiments, provides numerous advantages. For example, the use of Band 48 provides longer signal ranges and smoother handovers. The use of CBRS Band 48 supports numerous smart radios 224 and smart cameras 228 at the same time. A smart apparatus is therefore sometimes referred to as a Citizens Broadband Radio Service Device (CBSD).

In embodiments, the communication systems disclosed herein mitigate the network bottleneck problem when larger groups of workers are working in or congregating in a localized area of the facility. When a large number of workers are gathered in one area, the smart radios 224 they carry or wear creates too much demand for cellular networks or the cellular tower 212 to handle. To solve the problem, in embodiments, the cloud computing system 220 is configured to identify when a large number of smart radios 224 are located in proximity to each other.

In embodiments, the cloud computing system 220 anticipates where congestion is going to occur for the purpose of placing additional access points in the area. For example, the cloud computing system using the ML system 1400 to predict where congestion is going to occur based on bottleneck history and previous location data for workers. An example of network choke points are facility entry points where multiple workers arrive in close succession and clock in. The cloud computing system 220 accounts for congestion at such entry points by including additional access points at such locations. The cloud computing system 220 configures each smart radio 224a to relay data in concert with the other smart radios 224b, 224c. By timing the transmissions of each smart radio 224a, the radio waves from the cellular tower 212 arrive at a desired location, i.e., the desired smart radio 224a at a different point in time than the point in time the radio waves from the cellular tower 212 arrive at a different smart radio 224b. Simultaneously, the phased radio signals are overlaid to communicate with other smart radios 224c, mitigating the bottleneck.

The cloud computing system 220 delivers computing services—including servers, storage, databases, networking, software, analytics, and intelligence—over the Internet (“the cloud”) to offer faster innovation, flexible resources, and economies of scale. FIG. 2A depicts an exemplary high-level cloud-centered network environment 200 otherwise known as a cloud-based system. Referring to FIG. 2A, it can be seen that the environment centers around the cloud computing system 220 and the local networks 204, 208. Through the cloud computing system 220, multiple software systems are made to be accessible by multiple smart radio apparatuses 224, 232, smart cameras 228, 236, as well as more standard devices (e.g., a smartphone 244 or a tablet) each equipped with local networking and cellular wireless capabilities. Each of the apparatuses 224, 228, 244, although diverse, embody the architecture of apparatus 100 shown by FIG. 1, but are distributed to different kinds of users or mounted on surfaces of the facility. For example, the smart radio 224a is worn by employees or independent contracted workers at a facility. The CBRS-equipped smartphone 244 is utilized by an on or off-site supervisor. The smart camera 228 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radio apparatuses 224, 232, smart cameras 228, 236, smart phone 244).

In embodiments, the cloud computing system 220 and local networks 204, 208 are configured to send communications to the smart radios 224, 232 or smart cameras 228, 236 based on analysis conducted by the cloud computing system 220. The communications enable the smart radio 224 or smart camera 228 to receive warnings, etc., generated as a result of analysis conducted. The employee-worn smart radio 224a (and possibly other devices including the architecture of apparatus 100, such as the smart cameras 228, 236) are used along with the peripherals shown in FIG. 1 to accomplish a variety of objectives. For example, workers, in embodiments, are equipped with a Bluetooth enabled gas-detection smart sensor, implemented using the architecture shown in FIG. 1. The smart sensor detects the existence of a dangerous gas, or gas level. By connecting through the smart radio 224a or directly to the local network 204, the readings from the smart sensor are analyzed by the cloud computing system 220 to implement a course of action due to sensed characteristics of toxicity. The cloud computing system 220 sends an alert out to the smart radio 224 or smart camera 228, and thus a worker, for example, using speaker 146 or alternative notification means to alert the worker so that they can avoid danger. The speaker 146 is illustrated and described in more detail with reference to FIG. 1.

### Smart Peripheral Apparatuses

In embodiments, a peripheral biometric apparatus implemented using the architecture shown by FIG. 1 (e.g., incorporating heart rate, moisture sensors, etc.). The term “peripheral” means that the worker may not be required to use or carry the particular apparatus unlike the smart radio 224a. For example, the peripheral apparatus uses local network 204 and/or the cellular tower 212 to communicate with a biometrics analysis system. The biometrics analysis system operates on the cloud computing system 220 to detect danger indicating biometric conditions of the worker. Heart rates, dehydration, and other biometric parameters are monitored and analyzed by the cloud computing system 220. Further, warnings are transmitted to the worker through the smart radio 224a or to anyone else (e.g., a supervisor using apparatus 244) connected with the overall communication system.

In embodiments, the cloud computing system 220 detects abnormal biometric conditions using peripheral biometric smart sensors (e.g., dehydration, abnormally low heart rate). The cloud computing system 220 couples the information with readings from a gas-detection smart sensor (e.g., a reading reflecting the presence of hydrogen sulfide gas) to reach a conclusion that the worker needs to immediately get to safety. For example, the biometric and gas-detection devices 116 and 118 illustrated and described in more detail with reference to FIG. 1 are used. In embodiments, the cloud computing system 220 uses numerous means to communicate the warning to the worker. For example, the smart radio 224a includes a vibration warning system that warns the worker by vibration. Or the smart radio 224a uses the speaker 146 or Bluetooth peripherals illustrated and described in more detail with reference to FIG. 1.

In embodiments, the smart radio 224a is repurposed as a camera on site that provides video of the site, a node for peer-to-peer communication, and a point of triangulation for device location and identification. For example, if the video feed is of lower than suitable quality for identification of individual workers, the workers are labeled in the video based on the smart radio they are carrying. In an example, the smart radio or cloud computing system 220 operates a facial recognition system (e.g., using the ML system 1400 illustrated and described in more detail with reference to FIG. 14) to perform the labeling. The repurposed smart radio 224a provides imaging no matter how the smart radio 224a is being used. In embodiments, an additional external camera 228 is used that is physically separated from the smart radio 224a via Bluetooth. The smart camera 228 is optionally be used in place of built-in cameras in the smart radio 224a or in addition to the built-in cameras. The smart radio 224a would be configured to receive pictures taken by the external camera 228.

In embodiments, the smart radio 224a is configured to receive photos (e.g., via Bluetooth, another short-range wireless network, the local network 204, or a combination thereof) from other kinds of external peripheral cameras. For example, the peripheral cameras are wearable devices such as cameras mounted to glasses or helmets. The peripheral cameras provide a forward-facing view from the perspective of the worker while being operated hands-free. Alternatively, a peripheral camera 236 is positioned or mounted above a workstation/area, machinery, equipment, or another structure to provide an overhead view or an inside view of a contained area. The peripheral camera 236 provides an internal view of the contained area, and is positioned on a gimbal, swivel plate, rail, tripod, stand, post, and/or pole for enabling movement of the camera 236. Camera movement is controlled by the worker, under preprogrammed control via controller 110 or via another control mechanism. In embodiments, multiple views are displayed on display screen 130 from built-in cameras of the peripheral camera 236 (which are represented as one camera 165 in FIG. 1). Selection and enhancement (e.g., scrolling, panning, zooming) of views is provided via user-input means 150, for example. The display screen 130, camera 165, and user-input means 150 are illustrated and described in more detail with reference to FIG. 1. The built-in cameras, in embodiments, are digital-video cameras or high-definition digital-video cameras. Optional front and back cameras together enable the receipt of photo or video content from either side of the peripheral camera 236.

### Machine-Defined Interactions

The cloud computing system 200 uses data received from the smart radio apparatuses 224, 232 and smart cameras 228, 236 to track and monitor machine-defined interactions and collaborations of workers based on locations worked, times worked, analysis of video received from the smart cameras 228, 236, etc. An “interaction” describes a type of work activity performed by the worker. An interaction is measured by the cloud computing system 200 in terms of at least one of a start time, a duration of the activity, an end time, an identity (e.g., serial number, employee number, name, seniority level, etc.) of the worker performing the activity, an identity of the equipment(s) used by the worker, or a location of the activity. In embodiments, an interaction is measured by the cloud computing system 200 in terms of a vector (e.g., [time period 1, equipment location 1; time period 2, equipment location 2; time period 3, equipment location 3]). For example, a first interaction describes time spent operating a particular machine (e.g., a lathe, a tractor, a boom lift, a forklift, a bulldozer, a skid steer loader, etc.), performing a particular task, or working at a particular type of facility (e.g., an oil refinery).

A smart radio 224a carried or worn by a worker would track that the position of the smart radio 224a is in proximity to or coincides with a position of the particular machine. Example tasks include operating a machine to stamp sheet metal parts for manufacturing side frames, doors, hoods, or roofs of automobiles, welding, soldering, screwing, or gluing parts onto an automobile, all for a particular time period, etc. A lathe, lift, or other equipment would have sensors (e.g., smart camera 228 or other peripheral devices) that log times when the smart radio 224a is in proximity to the equipment and send that information to the cloud computing system 220.

In an example, a smart camera 228 mounted at a stamping shop in an automobile factory captures video of a worker working in the stamping shop and performs facial recognition or equipment recognition (e.g., using computer vision elements of the ML system 1400 illustrated and described in more detail with reference to FIG. 14). The smart camera 228 sends the start time, duration of the activity, end time, identity (e.g., serial number, employee number, name, seniority level, etc.) of the worker performing the activity, identity of the equipment(s) used by the worker, and location of the activity to the cloud computing system 220 for generation of one or more interaction(s).

The cloud computing system 220 also has a record of what a particular worker is supposed to be working on or is assigned to for the start time and duration of the activity. The cloud computing system 220 compares the interaction(s) computed with the planned shifts of the worker to signal mismatches if any. An example interaction describes work performed at a particular geographic location (e.g., on an offshore oil rig or on a mountain at a particular altitude). The interaction is measured by the cloud computing system 200 in terms of at least the location of the activity and one of a duration of the activity, an identity of the worker performing the activity, or an identity of the equipment(s) used by the worker. In embodiments, the machine learning system 1400 is used to detect and track interactions, for example, extracting features based on equipment types or manufacturing operation types as input data. For example, a smart sensor mounted on the oil rig transmits to and receives signals from a smart radio 224a carried or worn by a worker to log the time the worker spends at a portion of the oil rig.

A “collaboration” describes a type of group activity performed by a worker, for example, a group of construction workers working together in a team of two or more in an automobile paint facility, layering a chemical formula in a construction site for protection against corrosion and scratches, installing an engine into a locomotive, etc. A collaboration is measured by the cloud computing system 200 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. In embodiments, a collaboration is measured by the cloud computing system 200 in terms of a vector (e.g., [time period 1, equipment location 1, worker identities 1; time period 2, equipment location 2, worker identities 2; time period 3, equipment location 3, worker identities 3]).

Collaborations are detected and monitored using location tracking (as described in more detail with reference to FIG. 1) of multiple smart apparatuses. For example, the cloud computing system 220 tracks and records a specific collaboration based on determining that two or more smart radios 224 were located in proximity to one another within a specific geofence associated with a particular worksite for a predetermined period of time. For example, a smart radio 224a transmits to and receives signals from other smart radios 224b, 224c carried or worn by other workers to log the time the worker spends working together in a team with the other workers.

In embodiments, a smart camera 228 mounted at a paint facility captures video of the team working in the facility and performs facial recognition (e.g., using the ML system 1400). The smart camera 228 sends the location information to the cloud computing system 220 for generation of collaborations. Examples of data downloaded to the smart radios 224 to enable monitoring of collaborations include software updates, device configurations (e.g., customized for a specific operator or geofence), location save interval, upload data interval, and a web application programming interface (API) server uniform resource locator (URL). In embodiments, the machine learning system 1400, illustrated and described in more detail with reference to FIG. 14, is used to detect and track interactions (e.g., using features based on geographical locations or facility types as input data).

In embodiments, the cloud computing system 220 determines a “response time” metric for a worker. The response time refers to the time difference between receiving a call to report to a given task and the time of arriving at a geofence associated with the task. To determine the response time, the cloud computing system 220 obtains and analyzes the time the call to report to the given task was sent to a smart radio 224a of the worker from the cloud computing system 220, a local server, or a supervisor's device (e.g., smart radio 224b). The cloud computing system 220 obtains and analyzes the time it took the smart radio 224a to move from an initial location to a location associated with the geofence.

In some embodiments, the response time is compared against an expected time. Expected time is based on trips originating from a location nearby the starting location for the worker (e.g., from within a starting geofenced area, or a threshold distance) and ending at the geofence associated with the task, or a regional geofence that the task occurs within. Embodiments that make use of a machine learning model identify similar historical journeys that are similar as a basis of comparison.

In an example, the cloud computing system determines a “repair metric” for a worker and a particular type of equipment (e.g., a power line, etc.) For example, a repair metric identifies how frequently repairs by a given individual were effective. Effectiveness of repairs is machine observable based on a length of time a given object remains functional as compared to an expected time of functionality (e.g., a day, a few months, a year, etc.). After a worker is called to repair a given object, a timer begins to run. The timer is ended by either of a predetermined period expiring (e.g., expected usable life of repairs) or an additional worker being called to repair that same object.

Thus, where a second worker is called out to fix the same object prior to the expected usable life of the repair has expired, the original worker is assumed to have done a poor job on the repair and their respective repair metric suffers. In contrast, so long as a second worker has not been called out to repair the same object (as evidenced by location data and dispatch descriptions) during the expected operational life of the repairs, the repair metric of the first worker remains positive. The expected operation life of a given set of repairs is based on the object repaired. In some embodiments, a machine learning model is used to identify appropriate functional lifetimes of repairs based on historical examples.

The repair metric is determined by the cloud computing system 200 in terms of at least one of locations of the worker (e.g., traveling to the equipment), location of the equipment, time spent in proximity to the equipment, predetermined amount of time the equipment is expected to be operable (e.g., a day, a few months, a year, etc.) after repair, number of repairs, etc.

In another example, a repair metric relates to an average amount of time equipment is operable and in working condition after the worker visits the particular type of equipment the worker repaired. The repair metric is determined by the cloud computing system 200 in terms of at least one of a location of a smart radio 224a carried by the worker, time spent in proximity to the equipment, predetermined amount of time the equipment is expected to be operable (e.g., a day, a few months, a year, etc.) after repair, or location of the equipment. For example, if the particular type of equipment is operable for more than 60 days after the worker visited the equipment (to repair it), the repair metric of the worker with respect to the particular type of equipment is increased. If the equipment has broken within less than a week after the worker visited the equipment (to repair it), the repair metric of the worker with respect to the particular type of equipment is decreased. In embodiments, the machine learning system 1400, illustrated and described in more detail with reference to FIG. 14, is used to detect and track interactions (e.g., using features based on equipment types or defect reports as input data).

Another example of a repair metric for a worker relates to a ratio of the amount of time an equipment is operable after repair to a predetermined amount of time the equipment is expected to be operable (e.g., a day, a few months, a year, etc.) after repair. The predetermined amount of time changes with the type of equipment. For example, some industrial components wear out in a few days, while other components can last for years. After the worker repairs the particular type of equipment, the cloud computing system 220 counts until the predetermined amount of time for the particular type of equipment is reached. Once the predetermined amount of time is met, the equipment is considered correctly repaired, and the repair metric for the worker is incremented. If before the predetermined amount of time, another worker is called to repair the same equipment, the repair metric for the worker is decremented.

In embodiments, equipment is assumed/considered repaired until the cloud computing system 220 is informed otherwise. In such embodiments, the worker does not need to wait to receive credit to their repair metric in cases where the predetermined amount of time for particular equipment is large (e.g., months or years).

The smart radio 224a can track not only the current location of the worker, but also send information received from other apparatuses (e.g., the smart radio 224b, the camera 228) to contribute to the recorded locational information (e.g., of employees 306 at the facility 300 shown by FIG. 3). Because the smart radios 224 are readable by the cloud computing system 220, locational records can be analyzed to determine how well the different workers and other device users are doing in performing various tasks. For example, if a worker is inspecting a particular vessel in a refinery, it may be necessary for them to spend an hour doing so for a high-quality job to be performed. However, if the locational data record reveals that the worker was physically at the vessel for only two minutes, it would be an indication of hasty or incomplete work. The cloud computing system 220 can therefore track a “engagement metric” of time spent at a task with respect to the time required to be spent for the task to be performed.

In embodiments, the cloud computing system tracks the path chosen by a worker from a current location to a destination as compared to a computed direct path for determining “route efficiency.” For example, tracking records for multiple workers going from a contractor's building at the site to another point within the site can be used to determine (e.g., patterns in foot traffic). In an example, the tracking reveals that a worker chooses a pathway that causes them to go back and forth to a location on the site that is long and goes around many interfering structures. The added distances reduce cost-effectiveness because of where the worker is actually walking. Traffic patterns and the “route efficiency” of a worker monitored and determined by the cloud computing system 220 based on positional data obtained from the smart radios 224 is used to improve the worker's efficiency at the facility.

In embodiments, the tracking is used to determine whether one or more workers are passing through or spending time in dangerous or restricted areas of the facility. The tracking is used by the cloud computing system 220 to determine a “risk metric” of each worker. For example, the risk metric is incremented when time logged by a smart radio that the worker is wearing in proximity to hazardous locations increases. In embodiments, the risk metric triggers an alarm at an appropriate juncture. In another example, the facility or the cloud computing system 220 establishes geofences around unsafe working areas. Geofencing is described in more detail with reference to FIG. 1. The risk metric is incremented when the position of the smart radio is determined to be within the geofence even though the worker is not supposed to be within the geofence for the particular task. In another example, the risk metric is incremented when a position of the smart radio and sensors mounted on particular equipment indicate that the equipment is faulty or unsafe to use, yet the worker is using the equipment instead of signaling for replacement equipment to be provided. The logged position and other data are also used to generate records to build an evidence profile to be used in accident situations.

In embodiments, the established geofencing described herein enables the smart radio 224a to receive alerts transmitted by the cloud computing system 220. The alerts are transmitted only to the apparatuses worn by workers having a risk metric above a threshold in this example. Based on locational records of the apparatuses connected to the local network 204, particular movable structures within the refinery may be moved such that a layout is configured to reduce the risk metric for workers in the refinery (e.g., where the cloud computing system 220 detects that employees are habitually forced to take longer walk paths in order to get around an obstructing barrier or structure). In embodiments, the ML system 1400 is used to configure the layout to reduce the risk metric based on features extracted from coordinates of the geofencing, stored risk metrics, the locational records of the apparatuses connected to the local network 204, locations of the movable structures, or a combination thereof.

The cloud computing system 220 hosts the software functions to track operations, interactions, collaborations, and repair metrics (which are saved on one or more databases in the cloud) to determine performance metrics and time spent at different tasks and with different equipment, generate work experience profiles of frontline workers based on interfacing between software suites of the cloud computing system 220 and the smart radio apparatuses 224, 232, smart cameras 228, 236, smart phone 244. The cloud computing system 200 is, in embodiments, configured by an administrating organization to enable workers to send and receive data to and from their smart devices. For example, functionality desired to create an interplay between the smart radios and other devices with software on the cloud computing system 220 is configured on the cloud by an organization interested in monitoring employees, transmitting alerts to these employees based on determinations made by a local server or the cloud computing system 220. Amazon Web Services (AWS), Microsoft Azure, and Google Cloud are widely used examples of a cloud platform, but others could be used instead.

Tracking of interactions, collaborations, and repair metrics is implemented in, for example, Scheduling Systems (SS), Field Data Management (FDS) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.) Risk Based Inspection (RBI) software assists the facility using optimizing maintenance business processes to examine equipment and/or structures, and track interactions, collaborations, and repair metrics prior to and after a breakdown in equipment, detection of manufacturing failures, or detection of operational hazards (e.g., detection of gas leaks in the facility). The amount of time each worker logs at an interaction, collaboration, or other machine-defined activity with respect to different locations and different types of equipment is collected and used to update an “experience profile” of the worker on the cloud computing system 220 in real-time. The repair metric and engagement metric for each worker with respect to different locations and different types of equipment is collected and used to update the experience profile of the worker on the cloud computing system 220 in real-time.

### Experience Profile Features

FIG. 2B is a flow diagram illustrating an example process for generating a work experience profile using apparatuses 100, 242a, 242b, and communication networks 204, 208 for device tracking and geofencing, in accordance with one or more embodiments. The apparatus 100 is illustrated and described in more detail with reference to FIG. 1. The smart radios 224 and local networks 204, 208 are illustrated and described in more detail with reference to FIG. 2A. In embodiments, the process of FIG. 2B is performed by the cloud computing system 220 illustrated and described in more detail with reference to FIG. 2A. In embodiments, the process of FIG. 2A is performed by a computer system, for example, the example computer system 1500 illustrated and described in more detail with reference to FIG. 15. Particular entities, for example, the smart radios 224 or the local network 204, perform some or all of the steps of the process in embodiments. Likewise, embodiments can include different and/or additional steps, or perform the steps in different orders.

The experience profile that is automatically generated and updated by the cloud computing system 220 in real-time includes multiple profile layers that store a record of work history of the worker. In embodiments, an HR employee record is created that lists what each worker was doing during a particular shift, at a particular location, and at a particular facility to build an evidence profile to be used in accident situations. A portion of the data in the experience profile can follow a worker when they change employment. A portion of the data remains with the employer.

In step 272, the cloud computing system 220 obtains locations and time logging information from multiple smart apparatuses (e.g., smart radios 224) located at a facility. An example facility 300 is illustrated and described in more detail with reference to FIG. 3. The locations describe movement of the multiple smart apparatuses with respect to the time logging information. For example, the cloud computing system 220 track of shifts, types of equipment, and locations worked by each worker, and uses the information to develop the experience profile automatically for the worker, including formatting services. When the worker joins an employer or otherwise signs up for the service, relevant personal information is obtained by the cloud computing system 220 to establish payroll and other known employment particulars. The worker uses a smart radio 224a to engage with the cloud computing system 220 and works shifts for different positions. In embodiments, the cloud computing system 220 performs incident mapping based on the locations, time-logging information, shifts, types of equipment, etc. For example, the cloud computing system 220 determines where the worker was with respect to an accident when the accident occurred, and a timeline of the worker's locations before and after the accident. The incident mapping and the timeline is used to augment the risk metric described herein.

In step 276, the cloud computing system 220 determines interactions and collaborations for a worker based on the locations and the time logging information. Interactions and collaborations are described in more detail with reference to FIG. 2A. The interactions describe work performed by the worker with equipment of the facility (e.g., lathes, lifts, crane, etc.) The collaborations describe work performed by the worker with other workers of the facility. The cloud computing system 220 tracks the shifts worked, the amount of time spent with different equipment, interactions, collaborations, the relevant skills with respect to those shifts, etc.

The cloud computing system 220 generates a format for the experience profile of the worker based on the interactions and collaborations. The cloud computing system 220 generates the format by comparing the interactions and collaborations with respect to types of work performed by the worker with the equipment and the other workers. In an example, the cloud computing system 220 analyzes machine observations, such as location tracing of a smart radio a worker is carrying over a specific period of time cross-referenced with known locations of equipment.

In another example, the cloud computing system 220 analyzes contemporaneous video data that indicates equipment location. The machine observations used to denote interactions and collaborations are described in more detail with reference to FIG. 2A, for example, a start time, a duration of the activity, an end time, identities of the workers performing the activity, identity of the equipment(s) used by the workers, or a location of the activity.

The cloud computing system 220 assembles the information collected and identifies a format for the experience profile. The format is based on the information collected. Where a given worker has worked positions/locations with many different employers (as measured by threshold values), the format focuses on the time spent at the different types of work as opposed to individual employment. Where a worker has spent most of their time at a few specialized jobs (e.g., welding), the experience profile format is tailored toward employment that is related to that skill and deemphasizes unrelated employment (e.g., where the worker is a welder, time spent as a truck driver is not particularly relevant).

Where a given worker has worked on many (as measured by thresholds) shifts repeatedly with a given type of equipment, the experience profile format focuses on the worker's relationship with the given equipment. Based on the automated analysis, the system procedurally generates the experience profile content (e.g., descriptions of skills or attributes). The cloud computing system 220 includes multiple format templates that focus on emphasizing parts of the worker's experience profile or target jobs. Additional format templates are added based on evolving styles in various industries.

In embodiments, template styles are identified via the ML system 1400. In step 280, the cloud computing system 220 extracts a feature vector from the interactions and collaborations using an ML model. Example measures that the cloud computing system 220 uses to denote interactions by are described in more detail with reference to FIG. 2A, for example, a start time, a duration of the activity, an end time, identities of the workers performing the activity, identity of the equipment(s) used by the workers, or a location of the activity. The feature vector would be extracted from the measures. An example ML system 1400, example feature vector 1412, and an example ML model 1416 are illustrated and described in more detail with reference to FIG. 14. The feature vector describes types of work performed by the worker with the equipment and the other workers.

In step 284, the cloud computing system generates a format for an experience profile of the worker based on the feature vector using the ML model. The ML model is trained, based on stored experience profiles, to identify a format template for the format. The format includes multiple fields. To train the ML system 1400, information from stored experience profiles is input into the ML system 1400. The ML system 1400 interprets what appears on those stored experience profiles and correlates content of the worker's experience profile (e.g., time logged at particular experiences) to structure (e.g., how the experience profile is written). The ML system 1400 uses the worker's experience profile as compared to the data structures based on the training data to identify what elements of the worker's experience profile are the most relevant.

Similarly, the ML system 1400 identifies what information tends to not appear together and filters lower incidence data out. For example, when a worker has many (as measured by thresholds) verified or confirmed hours working with particular equipment, then experience at unskilled labor will tend not to appear on the worker's experience profile. In the example, the “lower incidence” data is the experience relating to unskilled work; however, the lower incidence varies based on the training data in the ML system 1400. The relevant experience data that is not filtered out is based on the experience profile content that tends to appear together across the training set. The population of the training set is configured to be biased toward particular traits (e.g., hours spent using complex equipment) by including more instances of experience profiles having complex equipment listed than non-skilled work.

For example, the listed work experience in the experience profile includes 350 hours spent working on an assembly system for injection valves or 700 hours spent driving an industrial lift jack system having hydraulic rams with a capacity of 1000 tons. Such work experience is collated by the ML system 1400 from location data of the worker, sensor data of the equipment, shift data, etc. In embodiments, especially embodiments relying upon the ML system 1400, a specific format template is not used. Rather, the ML system 1400 identifies a path in an artificial neural network where the generated experience profile content adheres to certain traits or rules that are template-like in nature according to that path of the neural network.

In step 288, the cloud computing system 220 generates the experience profile by filling the multiple fields of the format with information describing the interactions, the collaborations, repair metrics of the worker describing history of repairs to the equipment by the worker, and engagement metrics of the worker describing time spent by the worker working on the equipment. Repair metrics and engagement metrics are described in more detail with reference to FIG. 2A. The cloud computing system 220 automatically fills in fields/page space of the experience profile format identified. The data filled into the field space of the experience profile includes the specific number of hours that a worker has spent working with a particular type of equipment (e.g., 200 hours spent driving forklifts, 150 hours spent operating a lathe, etc.) Details used to fill in the format fields favor more recent experiences, interactions, and collaborations, or employment having stronger repair metrics and engagement metrics. In embodiments, the experience profile content is generated via procedural rules and predefined format template structures.

In embodiments, the cloud computing system 220 exports or publishes the experience profile to a user profile of a social or professional networking platform (e.g., such as LinkedIn™, Monster™, any other suitable social media or proprietary website, or a combination thereof). In embodiments, the cloud computing system 220 exports the experience profile in the form of a recommendation letter or reference package to past or prospective employers. The experience data enables a given worker to prove that they have a certain amount of experience with a given equipment platform.

To increase accuracy of determining a user's time or experience using any given piece of equipment, the equipment itself is affixed with a Bluetooth low energy (BLE) tag. When a user's smart radio reaches a threshold distance away from the BLE tag (e.g., 1 foot, 5 feet, etc.) and stays within that distance for a threshold period of time (e.g., 10 seconds, 30 seconds, 1 minute, etc.). Once the user (via the smart radio) is established within the threshold distance for the threshold time, the smart radio logs use of equipment time. In some embodiments a heartbeat check is applied to the distance between the smart radio and the BLE tag on the equipment.

Thresholds on a per equipment or an equipment class basis identify an intro distance, a break distance, and dwell time. A given user is “using” equipment once they have come at least as close as the intro distance and remained for a threshold dwell time (avoids passing by use). The user stops using the equipment after exceeding a break distance for a threshold time.

Data pertaining to a given worker is organized into multiple tiers. In some embodiments, the tiers are structured into an individual basis, as connected to the contract they are working, and as connected to their employer. Each of those tiers operates identity management within the cloud computing system 220. When a worker ceases to work for an employer or cease to work on a contract, their individual data (e.g., their training, what they did) continues to follow them through the system to the next employer/contract they are attached to. Data is conserved in escalating tiers such that individual data is stored to the contract level and stored to the employer level.

Conversely, data pertaining to the contract (e.g., performance data, hours worked, accident mapping) stays with the contract tier. Similarly, data pertaining to the employer tier (e.g., the same as contract data across multiple contracts) remains with the employer.

Users are part of a global directory of login profiles to the smart radios (or other interface platforms). Regardless of which employer/facility/project/other group delineation the user is associated with, the user logs in to the smart radio using the same login identity. The global directory enables traceability of otherwise transient workers. The global directory improves efficiency or emergency response by enabling quicker decision making and also allowing different permissions in different facilities for the same user. Each user has a seamless experience in multiple facilities and need not worry about multiple passwords per group delineation.

FIG. 3 is a drawing illustrating an example facility 300 using apparatuses and communication networks for device tracking and geofencing, in accordance with one or more embodiments. For example, the facility 300 is a refinery, a manufacturing facility, a construction site, etc. An example apparatus 100 is illustrated and described in more detail with reference to FIG. 1. The communication technology shown by FIG. 3 is implemented using components of the example computer system 1500 illustrated and described in more detail with reference to FIG. 15.

Multiple differently and strategically placed wireless antennas 374 are used to receive signals from an Internet source (e.g., a fiber backhaul at the facility), or a mobile system (e.g., a truck 302). The wireless antennas 374 is similar to or the same as the wireless antenna 174 illustrated and described in more detail with reference to FIG. 1. The truck 302, in embodiments, includes the edge kit 172 illustrated and described in more detail with reference to FIG. 1. The strategically placed wireless antennas 374 repeat the signals received and sent from the edge kit 172 such that a private cellular network (e.g., the local network 204 illustrated and described in more detail with reference to FIGS. 2A and 2B) is made available to multiple workers 306. Each worker carries or wears a cellular-enabled smart radio. The smart radio is implemented using the apparatus 100 illustrated and described in more detail with reference to FIG. 1. As described in more detail with reference to FIG. 1 and FIGS. 2A and 2B, a position of the smart radio is continually tracked during a work shift.

In implementations, a stationary, temporary, or permanently installed cellular (e.g., LTE or 5G) source (e.g., edge kit 172) is used that obtains network access through a fiber or cable backhaul. In embodiments, a satellite or other Internet source is embodied into hand-carried or other mobile systems (e.g., a bag, box, or other portable arrangement). FIG. 3 shows that multiple wireless antennas 374 are installed at various locations throughout the facility. Where the edge kit 172 is located at a location near a facility fiber backhaul, the communication system in the facility 300 uses multiple omnidirectional Multi-Band Outdoor (MBO) antennas as shown. Where the Internet source is instead, located near an edge of the facility 300, as is often the case, the communication system uses one or more directional wireless antennas to improve the coverage in terms of bandwidth. Alternatively, where the edge kit, if in a mobile vehicle, for example, truck 302, the antennas' directional configuration would be picked depending on whether the vehicle would ultimately be located at a central or boundary location.

In embodiments where a backhaul arrangement is installed at the facility 300, the edge kit 172 is directly connected to an existing fiber router, cable router, or any other source of Internet at the facility. In embodiments, the wireless antennas 374 are deployed at a location in which the apparatus 100 (e.g., a smart radio) is to be used. For example, the wireless antennas 374 are omnidirectional, directional, or semi-directional depending on the intended coverage area. In embodiments, the wireless antennas 374 support a local cellular network (e.g., the local network 204 illustrated and described in more detail with reference to FIG. 2A). In embodiments, the local network is a private LTE network (e.g., based on 4G or 5G). In embodiments, the local network is implemented using the ISM radio bands. For example, the network 204 uses the 900 MHz band. In another example, the local network uses 900 MHz for voice and narrowband data for land mobile radio (LMR) communications, 900 MHz broadband for critical wide area, long-range data communications, and the 2.4-2.6 GHz band for ultra-fast coverage of smaller areas of the facility, such as substations, storage yards and office spaces. In another example, Citizens Broadband Radio Service (CBRS) is used for ultra-fast coverage of smaller areas of the facility.

In alternative embodiments, the network is a Band 48 CBRS local network. The frequency range for Band 48 extends from 3550 MHz to 3700 MHz and is executed using Time Division Duplexing (TDD) as the duplex mode. The private LTE wireless communication device 105 (illustrated and described in more detail with reference to FIG. 1) is configured to operate in the private network created, for example, configured to accommodate Band 48 CBRS in the frequency range for Band 48 (again, from 3550 MHz to 3700 MHz) and accommodates TDD. Thus, channels within the preferred range are used for different types of communications between the cloud and the local network.

FIG. 4 is a drawing illustrating example apparatuses for device tracking and geofencing, in accordance with one or more embodiments. The apparatuses shown by FIG. 4 are smart radios. The smart radios are implemented using components of the example computer system 1500 illustrated and described in more detail with reference to FIG. 15.

The features of the smart radio include an easy to grab volume control dial that can be used to, with one hand, increase or decrease the volume of the device as well as a push-to-talk button 420. The volume control controls the loudness of the smart radio (e.g., the speaker of the audio device 146 illustrated and described in more detail with reference to FIG. 4), while the push-to-talk button 420, when depressed, enables voice transmissions/messages to be sent to other smart device (e.g., the smart camera 228 illustrated and described in more detail with reference to FIGS. 2A and 2B). Electronic circuits in the smart radio's controller 110 enable signals from the push-to-talk button 420 and the volume control to result in the desired functions. The controller 110 is illustrated and described in more detail with reference to FIG. 1.

FIG. 5 is a drawing illustrating example apparatuses for device tracking and geofencing, in accordance with one or more embodiments. A user-input system is implemented on the smart radios (illustrated in more detail in FIG. 4) for receiving user inputs and transmitting the user inputs to controller 110. The controller 110 is illustrated and described in more detail with reference to FIG. 1. User inputs include any user-input means including but not limited to touch inputs, audible commands, a keyboard, etc. In the embodiments of the smart radio depicted in FIG. 5, a user-input device includes multiple navigational tools that are operable by the finger/thumb of a worker. As depicted in FIG. 5, the navigational tools include a down navigational button 512, an up navigational button 508, a selection button 516, and a back/home button 504. In some embodiments, the down and up navigational buttons 508, 512 are constructed in a concave arrangement to enable gloved hands to more readily identify the bounds of each button.

To enable operation of the buttons and other navigational means of the smart radio by a worker wearing work gloves, the buttons described herein click at a predetermined force/psi. The predetermined force/psi is selected such that a heavy touch by a gloved finger or hand will not result in multiple clicks and that a touch will not depress multiple buttons. The down navigational button 512 and up navigational button 508 enable scrolling up or down through displayed content, and the outwardly extending selection button 516 is depressible to select menu options. The back/home button 504 enables a worker to back out of selected options and ultimately to return to a home screen. The other handheld devices (e.g., smart camera 228 illustrated and described in more detail with reference to FIGS. 2A and 2B) will use other kinds of arrangements (e.g., a touchscreen, or other buttons) without departing from the scope hereof. An example text messaging display 240 is illustrated in FIG. 2A.

In embodiments, the buttons shown by FIG. 5 or other user-input means of the smart radio disclosed include capacitive sensors to disable the buttons and other input means when pressed by or in contact with bare human skin. The benefits of the embodiments include prevention of use of the smart radio or other smart apparatus by a worker who is not suitably gloved for work. For example, for worksite safety, the back/home button 504 is rendered inoperable by a Touch ID sensor when depressed by a bare hand or finger.

### Long Range Transmission Mesh Network Backhaul

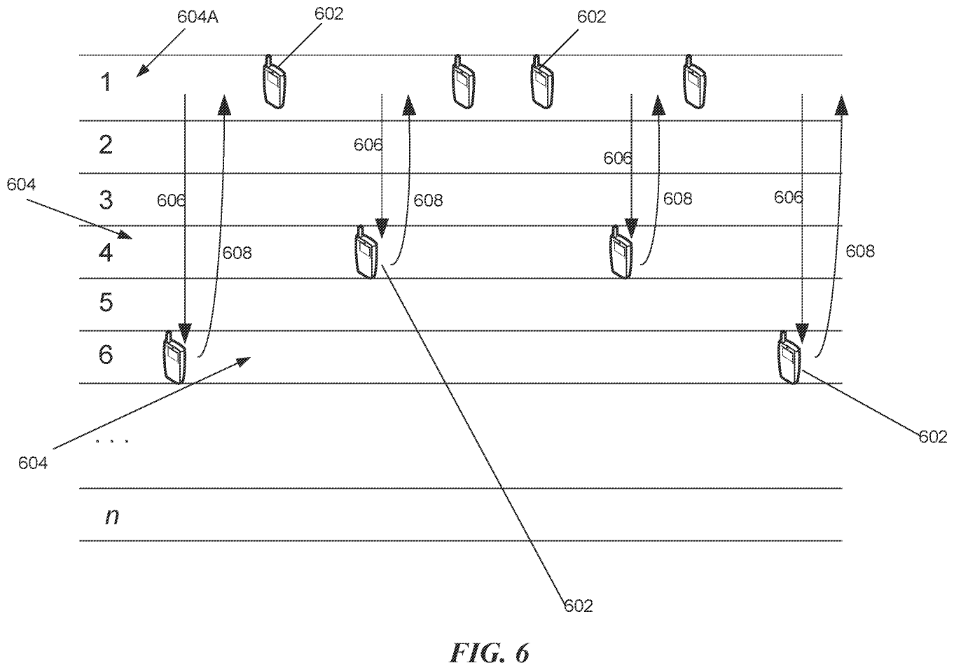

FIG. 6 is a drawing illustrating the use of a backhaul. Above, embodiments of smart radios 602 were described as having multiple SIM cards for different networks and including multiple radios associated thereto (see FIG. 2A and associated text). In related embodiments described above, one of the networks is a local radio-based network using peer to peer two-way radio (duplex communication) with extended range based on hops-a long range transmission mesh network system. In some embodiments the long range transmission mesh network system makes use of a backhaul channel to coordinate communications 604A. Alternatively, in some embodiments, a GMRS/FRS system (as described above) makes use of a backhaul channel to coordinate communications 604A.

The long range transmission mesh network backhaul is one of a number of coordination channels available to the smart radio 602. The smart radios 602 include 2.4/5/6 Ghz antenna that communicate on wireless protocols (e.g., 802.11/WiFi protocols) or machine to machine protocols (e.g., Bluetooth protocols) as well. The smart radios 602 further include a low-bitrate protocol (e.g., Codec 2), and communicate in the 900 MHz band. In a given population of smart radios 602 it is contemplated that some will have service under the 2.4/5/6 Ghz band, some will have connectivity through the 900 MHz band, and some will have connectivity through both networks. Through onboard software the coordination of the two networks is merged. The embodiment of the long range transmission mesh network backhaul is therefore not necessarily the only coordination path for devices on an otherwise greater or merged network. The 900 MHz band operates as a backup network for communication where the associated 2.4/5/6 Ghz network has exceed signal range or is otherwise interfered with. In some embodiments, the GMRS/FRS network operates as the backup network for communication where the associated 2.4/5/6 Ghz network has exceeded signal range or is interfered with.

The above-described embodiments use packet-based data with packet switching by each smart radio or other smart apparatus on the path from source to destination. “Packets” are interpreted based on audio received over the mesh network. The audio is unintelligible to humans but is coherent to software onboard the smart radios (e.g., with an audio codec). The data is encrypted in that incoherent auditory output is effectively ciphered. For example, each smart radio 602 or other smart apparatus operates as a transmitter, receiver, or transceiver for the local network. The smart apparatuses serve as multiple transmit/receive sites interconnected to achieve the range of coverage required by the facility.

In some embodiments, the audio on the backhaul channel is intelligible, and is computer generated audio (e.g., computer generated speech synthesis, text to speech, metadata globally unique ID, etc.). The audio, while intelligible, is still processed by a codec that enables the smart radio 602 to take automatic action based on the content of the audio. In some embodiments, despite the audio being intelligible, that audio is not emitted by the smart radios 602 on the backhaul channel in order to prevent spamming the user of the smart radio 602. The user does not need to hear the coordination messages on the backhaul channel as the smart radio 602 takes automatic action based thereon.

In some embodiments, the data transmitted on the backhaul is not encrypted, but is not necessarily human intelligible either. Specifically, use of globally unique identifiers (GUID) is used to identify a broadcast device, target device, and a target channel to move to. Given that data received on the backhaul channel, associated smart radios 602 automatically switch to a coordinated channel where speech occurs normally. Similarly to embodiments as described above, despite the audio not being encrypted, that audio is not emitted by the smart radios 602 on the backhaul channel in order to prevent spamming the user of the smart radio 602. In some embodiments, a metadata blast proceeds each transmission by the user. The metadata blast is not emitted by the speakers of smart radios 602 that are configured to interpret the metadata, further, the smart radio 602 uses the metadata to selectively mute certain users (identified by the metadata) at certain times based on on-board software configuration that coordinates which users are seeking to speak to one another at a time. Leading each broadcast with metadata (that is otherwise muted) does cause a slight delay in communication for insertion of the metadata; however, the delay is not significant as the length of the metadata preambles are a fraction of a second.

The mesh network makes use of multiple channels 604. Typically, users will agree upon a channel 604 to use, switch to that channel and converse normally. As disclosed here, each user is defaulted to a common, backhaul channel 604A. In the backhaul channel 604A, the smart radio 602 receives transmissions in unintelligible audio that is interpreted by the device itself. Where a given user wishes to speak to another user, the first user will indicate the desired users on an initial message. The initial message includes a channel designation, when received and processed, each smart radio 602 referred to in the initial message automatically switches 606 to the designated channel and communication commences between the selected users. In some embodiments, GMRS makes us of multiple channels 604.

In some embodiments, the smart radios 602 via backhaul coordination make use of a channel rotation scheme whereby users that are participants in a given smart radio facilitated conversation are automatically rotated to different channels using time division with other similarly situated conversing users (e.g., two users on channel 5 and two users on channel 8 swap channels simultaneously). The channel rotation enables a degree of privacy from an entity listening to the conversation on open otherwise open and public radio channel frequencies (e.g., eavesdroppers without a smart radio 602 with onboard programming to interpret the radio backhaul coordination).

In various embodiments, communication on the designated channel is either encrypted (as described above) or traditional, unencrypted ISM signal audio. When the users are done with their conversation as indicated via idling, or active interface indications, the smart radios 602 are returned 608 to the designated long range transmission mesh network backhaul channel 604A.

The backhaul is configured to enable priority or emergency channels. Where one channel is the backhaul (ex: channel 1), some configurations designate another channel (ex: channel 2) as a priority access or emergency channel. Users are routed to this channel on when their smart radio has indicated emergency use, for example via circumstantial or identity metadata. Emergency use is one example, but VIP use is another feasible example for use of the priority channel.

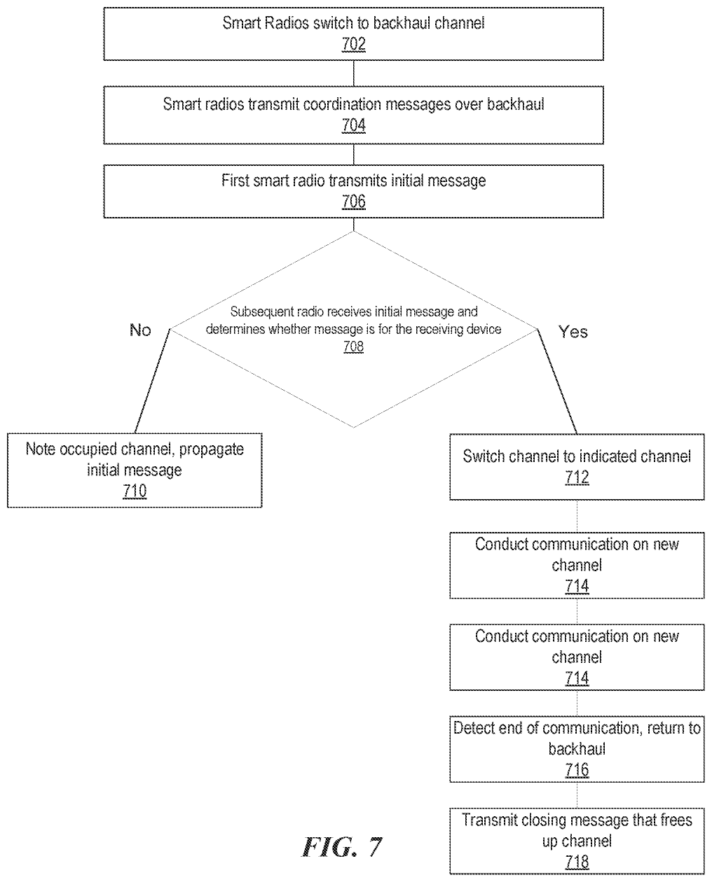

FIG. 7 is a flow diagram illustrating the use of a backhaul. In some embodiments, a long range transmission mesh network system makes use of a backhaul channel, as described above. In some embodiments, a GMRS/FRS system makes use of a backhaul channel. In step 702, a set of smart radios are automatically switched to a first mesh network channel that is operated as a backhaul. In step 704, the smart radios transmit audio processed by the smart radios when received (and not emitted by the devices). The processing of the audio coordinates a network of the smart radios on the mesh network backhaul channel. Audio is processed via a codec installed on each of the smart radios or by interpretation of available metadata via software configuration installed on the smart radios. The coordination audio indicates which channels are open and which are being used.

In some embodiments, the smart radios listen to the backhaul channel simultaneously while operating on a “speaking” channel. Hardware capable of tuning to multiple frequencies the listening/communicating on multiple channels simultaneously. Where such hardware is unavailable, the smart radios request updates from other devices when returning to the backhaul channel from having been on a speaking channel.

In step 706, a first smart radio transmits an initial message that indicates a particular user (as associated with a given smart radio) and a channel that is automatically determined based on available channels indicated via messages on the backhaul channel. In step 708, as each device receives the initial message, that device processes the message to the extent necessary to determine whether the initial message refers to the user of the subject device, and what channel is being newly occupied. The smart radio makes use of an audio codec to process the initial message. In various embodiments, the codec processed audio is either of intelligible or unintelligible (by humans).

In step 710, where the initial message is not directed at the user of the subject device, the subject device determines which channel is intended to be occupied by the users associated with the initial message, and then propagates the initial message within the subject device's transmit range.

In step 712, where the initial message is directed at the user of the subject device, the subject device automatically switches to the channel indicated by the initial message. In some embodiments, a switch of channels is not performed until confirmation/handshaking messages have been sent/received. In step 714, communication occurs between the users on the new channel. Communication occurs via intelligible mesh network audio transmission and/or via audio codec processed audio. In some embodiments, the devices on the new channel rotate via predetermined time division to a different channel in order to improve privacy.

In step 716, when the users are done with their conversation as indicated via idling, or active interface indications, the smart radios are automatically returned to the designated mesh network backhaul channel. In step 718 a closing message is transmitted by each of the participants of the conversation over the backhaul channel using the same means as the initial message indicating that the channel is clear to use. The smart radios that receive the initial or closing message keep a log of which channels are open for use.

In embodiments where the smart radios do not have the hardware to listening to both the backhaul and speaking channel, updates as to channels in use are queried on the backhaul channel upon returning thereto. In some embodiments, updates to available mesh network channels are informed via an associated 2.4/5/6 Ghz network that the smart radios are additionally configured with.

### Long Range Transmission Mesh Network

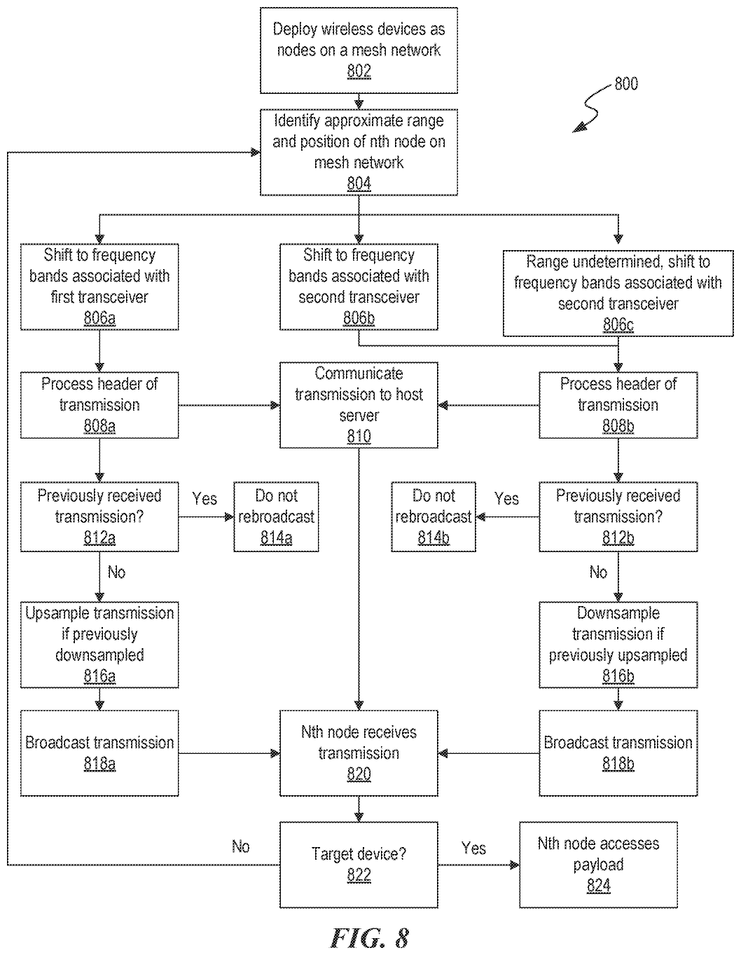

FIG. 8 is a block diagram illustrating an example long range transmission mesh network, in accordance with one or more embodiments. The nodes of the mesh network 800 are configured to enable a transmission to hop from node to node, as described below. The mesh network 800 is implemented using wireless devices (e.g., wireless handsets) configured with (1) a first transceiver configured to communicate using wireless and machine to machine protocols operating within a first wireless band, and (2) a second transceiver configured to communicate using a low-bit rate protocol operating within a second wireless band that is a lower frequency than the first wireless band. For example, in some embodiments, the first transceiver is configured to operate using wireless and machine to machine protocols within the 2.4-2.6 GHz band, and the second transceiver is configured to operate using a long range (LoRa) chip set with a Codec 2 protocol within the 900 MHz band. In some embodiments the wireless devices are implemented using the architecture of FIG. 1.

In step 802 the wireless devices are deployed as nodes on the mesh network. For example, a first wireless device is deployed as a first node, a second wireless device is deployed as a second node, a third wireless device is deployed as a third node, and so on. For simplicity, this will be referred to as an nth wireless device being deployed as an nth node on the mesh network. In some embodiments, each of the nodes is a wireless device as described above.

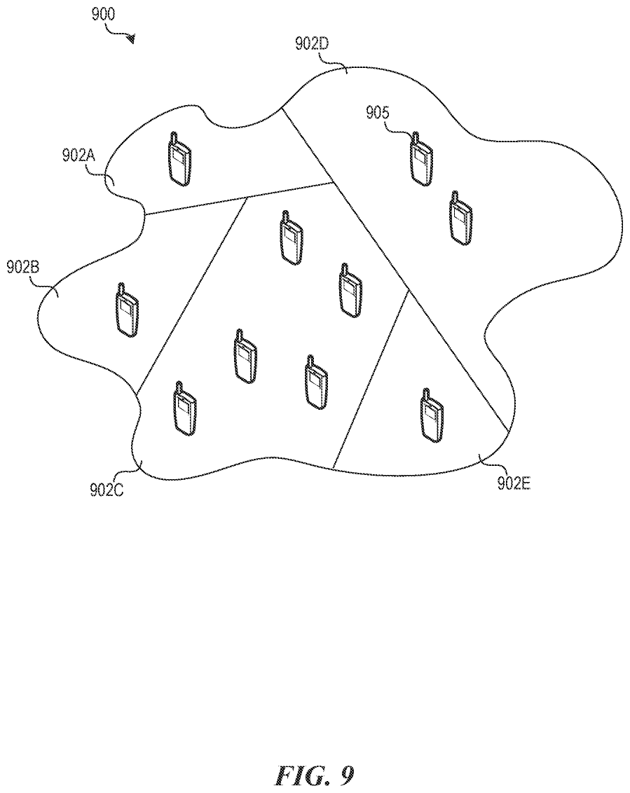

In step 804 the wireless device identifies an approximate range and position of an nth node on the mesh network. For example, the first wireless device identifies an approximate range and position of the second node. In some embodiments, the wireless device identifies the approximate range of the nth node at least in part by periodically transmitting a range request signal to the nth node. For example, in some embodiments, the wireless device periodically transmits a received signal strength indicator (RSSI) signal via a Bluetooth protocol to the nth node. In some embodiments, the wireless device triangulates the approximate position of the nth node by processing a plurality of range request signals responded to by the nth node. In some embodiments, the wireless device identifies the approximate range and position of the nth node at least in part by using the approximate range and position of geofence areas (described in more detail with reference to FIG. 9).

In step 806 the wireless device automatically shifts frequency bands based on the approximate range and position of the nth node. For example, in step 806a, based on the approximate range and position of the nth node, the wireless device shifts to frequency bands associated with the first transceiver (e.g., 2.4-2.6 GHz). As another example, in step 806b, based on the approximate range and position of the nth node, the wireless device shifts to frequency bands associated with the second transceiver (e.g., 915 MHz). In step 806c, in some embodiments, if the approximate range and position of the nth node is undetermined by the wireless device, the wireless device shifts to frequency bands associated with the second transceiver.

In steps 808a and 808b the wireless device processes a header of a transmission (described above with reference to FIG. 2A). Data in the header is used by the wireless device to direct the transmission to a target device (e.g., the nth node). For example, the wireless device processes the header of the transmission, which directs transmission to the nth node. In some embodiments, the target device includes the architecture of the wireless device described above. In some embodiments the target device is implemented using the architecture of FIG. 1.

In step 810, in some embodiments, the wireless device communicates the transmission to a host server. For example, based on network connectivity of the wireless device, the wireless device communicates to the host server via the Internet. In some embodiments, the host server is implemented using the server/cloud computing architecture of FIGS. 1 and 2A. In some embodiments, the host server is configured to communicate the transmission to the nth node.

In steps 812a and 812b, the wireless device determines from the header of the transmission whether the wireless device has previously received the transmission. If the wireless device has already received the transmission, the wireless device is configured to not rebroadcast the transmission, as shown in steps 814a and 814b.

In step 816a, in some embodiments, the wireless device is configured to upsample the transmission if it was previously downsampled. For example, in some embodiments, the wireless device identifies the approximate range and position of the nth node (e.g., step 804) and shifts to frequency bands associated with the first transceiver (e.g., step 806a). If the wireless device receives the downsampled transmission with a header directing transmission to the target device (which may or may not be the nth node), the wireless device upsamples the transmission while broadcasting the transmission, as shown in step 818a. In step 816b, in some embodiments, the wireless device is configured to downsample the transmission if it was previously upsampled. For example, in some embodiments, based on the approximate range of the nth node, the wireless device shifts to frequency bands associated with the second transceiver (e.g., step 806b). If the wireless device receives the upsampled transmission with the header directing transmission to the target device (which may or may not be the nth node), the wireless device downsamples the transmission while broadcasting the transmission, as shown in step 818b. In another example, the wireless device is unable to determine the approximate range and position of the nth node (which may or may not be the target device) and shifts to frequency bands associated with the second transceiver (e.g., step 806c). The wireless device downsamples a transmission originating from the wireless device while broadcasting the transmission, as shown in step 818b.

In some embodiments the wireless device receives the downsampled transmission, shifts to frequency bands associated with the first transceiver (e.g., step 806a), and broadcasts the downsampled transmission (e.g., step 818a) without upsampling. Skipping upsampling reduces the processing time and/or resources associated with upsampling the downsampled transmission after each hop on the mesh network.

In step 820 the nth node receives the transmission. In some embodiments the nth node receives the transmission from one or more other nodes on the mesh network, and/or from the host server. In step 822 the nth node processes the header of the transmission and determines if the nth node is the target device. In some embodiments, if the nth node is the target device, then the nth node accesses a payload of the transmission, as shown in step 824. In some embodiments, if the transmission was downsampled when the nth node received it, the nth node is configured to upsample the transmission. If the nth node is not the target device, then the nth node repeats the process, starting by identifying the approximate range and position of another node on the mesh network, as shown in step 804.

A high level example follows: A first wireless device configured as described above is deployed as a first node on a mesh network, as shown in step 802. The first wireless device identifies the approximate range of a second node on the mesh network by periodically transmitting RSSI signals to the second node and triangulates the approximate position of the second node by using a plurality of responses from the second node, as shown in step 804. Based on the approximate range and position of the second node, the first wireless device shifts to frequency bands associated with the second transceiver (e.g., 915 MHz), as shown in step 806b.

The first wireless device originates a transmission with a header designating a third node as a target device. The first wireless device processes the header of the transmission as shown in step 808b, determines that the first wireless device has not previously received the transmission as shown in step 812b, downsamples the transmission as shown in step 816b, and broadcasts the transmission as shown in step 818b. The first wireless device also communicates the transmission to a host server via the Internet, as shown in step 810. The second node receives the transmission from the first wireless device, as shown in step 820.

The second node later receives the transmission from the host server. The second node processes the header of the transmission and determines that it is not the target device, as shown in step 822. The second node is a second wireless device configured as described above, similar to the first wireless device. The second node identifies an approximate range and position of the third node on the mesh network (which happens to be the target device), as shown in step 804. Based on the approximate range and position of the third node, the second node shifts to frequency bands associated with the first transceiver (e.g., 2.4-2.6 GHz), as shown in step 806a.

The second node processes the header of the transmission as shown in step 808a, determines that the second node has not previously received the transmission as shown in step 812a, upsamples the transmission (since the transmission was previously downsampled by the first wireless device) as shown in step 816a, and broadcasts the transmission as shown in step 818a. The second node also communicates the transmission to the host server as shown in step 810. The third node receives the transmission from the second node and the host server, as shown in step 820. The third node determines from the header of the transmission that it is the target device, and thus gains access to a payload as shown in step 824.

### Location-Based Features

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices (e.g., position tracking component 125, position estimating component 123) that inform of the location of the smart radio at various times. Embodiments described herein relate to location-based features for smart radios or smart apparatuses. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

Additional features include image viewing and camera operation disabled by certain locations, location tracking on form completion, and automated muster locations.

### Responder-Targeted Communications

Some example scenarios that require radio communication between workers are area-specific, or relevant to a given area of a facility. As one example, a local hazardous event in a given area of a facility is not hazardous to other workers in other areas that are remote. As another example, a downed (e.g., injured, disabled) worker in a given area of a facility requires immediate assistance and that attention is unlikely to be provided from other workers in other areas. The use of geofences to define various areas within a facility or worksite provides a means for defining area-specificity of various scenarios and events. In some embodiments, the use of geofences is used to coordinate mesh connectivity of a long range transmission mesh network, for example, the long range transmission mesh network described in more detail with reference to FIG. 8.

Radio communication with workers located in a given area is needed to handle area-specific scenarios relevant to the given area. In some examples, the communication is needed at least to transmit alerts to notify the workers of the area-specific scenario and to convey instructions to handle and/or remedy the scenario.

According to some embodiments, locations of smart radios are monitored (e.g., by cloud computing system 220) such that at a point in time, each smart radio located in a specific geofenced area is identified. FIG. 9 illustrates an example of a worksite 900 that includes a plurality of geofenced areas 902, with smart radios 905 being located within the geofenced areas 902.

In some embodiments the geofenced areas 902 are used to coordinate mesh connectivity for a long range transmission mesh network (e.g., the long range transmission mesh network described in FIG. 8). For example, a host server provides an approximate range and approximate position of the geofenced areas 902 to smart radios 905 that operate as nodes on a mesh network (e.g., the wireless devices described in FIG. 8). In some embodiments, the smart radios 905 use the approximate range and position information to shift to frequency bands associated with a first transceiver or frequency bands associated with a second transceiver (e.g., the first and second transceivers described in FIG. 8).

For example, the host server provides smart radios 905 in geofenced area 902A with approximate range and position information of geofenced area 902B. In some embodiments, the smart radios 905 (e.g., the wireless devices of FIG. 8) use the approximate range and position information of geofenced area 902B to shift to the 2.4-2.6 GHz band. Alternatively, the host server provides smart radios 905 in geofenced area 902A with approximate range and position information of geofenced area 902E. In some embodiments, the smart radios 905 use the approximate range and position information of geofenced area 902E to shift to the 915 MHz band.

In some embodiments, an alert, notification, communication, and/or the like is transmitted to each smart radio 905 that is located within a geofenced area 902 (e.g., 902C) responsive to a selection or indication of the geofenced area 902. A smart radio 905, an administrator smart radio (e.g., a smart radio assigned to an administrator), or the cloud computing system 220 is configured to enable user selection of one of the plurality of geofenced areas 902 (e.g., 902C). For example, a map display of the worksite 900 and the plurality of geofenced areas 902 is provided. With the user selection of a geofenced area 902 and a location for each smart radio 905, a set of smart radios 905 located within the geofenced area 902 is identified. An alert, notification, communication, and/or the like is then transmitted to the identified smart radios 905.

However, in various examples, technical challenges arise with mass communication with each worker located in a given area. That is, despite an area-specific scenario potentially being relevant to each worker, communication with all workers located in the area requires a significant amount of resources and time. For example, in the illustrated example of FIG. 9, the geofenced area 902C includes five smart radios. Inefficiencies and delays in response time arise when communication with all five smart radios is attempted. Further, if continued communication is needed following an initial alert or notification, not all workers are guaranteed to have seen and read the initial alert or notification. Thus, in some examples, repetition of information redundant with an initial communication is needed for workers who have not actually seen the initial communication. Additionally, with different geofenced areas 902 having a different number of smart radios 905, area-wide communication for different areas becomes inconsistent and potentially unreliable.

Accordingly, embodiments described herein provide response-ordered communication with local smart radios to address at least these identified technical challenges. In particular, example embodiments establish communications with a selected subset of smart radios 905 located within a geofenced area 902C. The subset of smart radios 905 is selected based on a response time to an initial communication transmitted to each of a superset of smart radios within the geofenced area 902C.

As such, example embodiments enable efficient and rapid handling of area-specific scenarios due to the selection of smart radios based on response time. Smart radios with responsive behavior are selected, which results in continued communication with workers who are adequately informed and prepared to handle the area-specific scenario. This results in communication resources not being spent on non-selected smart radios whose workers are delayed in being informed of the area-specific scenario (e.g., workers that are busy and occupied with other matters).

An illustrative non-limiting example is described with reference to FIG. 9, and the geofenced area 902C with five smart radios. As discussed above, inefficient operational delays occur with communicating via each of the five smart radios. For example, a given worker is occupied and distracted by another task and fails to become aware of an emergency that is alerted via a smart radio. As such, the given worker is not adequately prepared or briefed for continued communication to allow for responding to and handling the emergency. Establishing the continued communications with the otherwise occupied worker would result in inefficiencies in the response and handling of the emergency.

Accordingly, a subset of the five smart radios are selected based on response time to an initial communication transmitted to each of the five smart radios. For example, the first two smart radios to respond by performing an activity related to the initial communication are selected. As another example, smart radios that perform an activity within a threshold time of the initial communication are selected.

That is, response time refers to a time that passes before a smart radio performs an activity related to and/or in response to an initial communication. In some embodiments, response time is measured as a time spanning between when the initial communication is received by the smart radio and when an activity is detected at the smart radio.

In some embodiments, the activities at a smart radio that control response time are related to user interactions by a worker with the smart radio. For example, response time is determined based on when a worker reads the initial communication. In an example, the reading of the initial communication is detected based on the initial communication being displayed for a threshold amount of time. In another example, the reading of the initial communication is detected based on a display of the initial communication being initiated (e.g., responsive to a user interaction with a displayed notification of the initial communication). In yet another example, the reading of the initial communication is detected based on a threshold degree of movement or jostling that is measured via a gyroscope, an accelerometer, and/or similar sensors on the smart radio.

As another example, response time is determined based on a response transmitted by the smart radio. For example, the response time is determined based on the smart radio transmitting an acknowledgement, a receipt, and/or the like back to an administrator smart radio from which the initial communication was transmitted. In an example, the acknowledgement, receipt, and/or the like is transmitted in response to a command from the worker. As such, the acknowledgement, receipt, and/or the like is representative of the initial communication reaching the worker.

These and other example activities are detected and used to determine response times for different smart radios. As discussed, smart radios with short response times (e.g., compared to other smart radios, within a threshold time) are selected, and further communication is established with the selected smart radios. For example, a communication channel (e.g., a video call, an audio call, a text conversation or thread) is initiated between the administrator smart radio and the selected smart radio(s).

Accordingly, an administrator is able to communicate further details and instructions to worker(s) at the selected smart radio(s) via the initiated communication channel. The worker(s) is likely to have seen the initial communication and have an initial informed awareness of an area-specific scenario. The administrator does not need to repeat information and directly communicate further details or instructions, thus saving critical time needed to handle and respond to scenarios in the facility. As such, technical benefits are provided by establishing communications with a first responder audience selected from a localized population of workers.

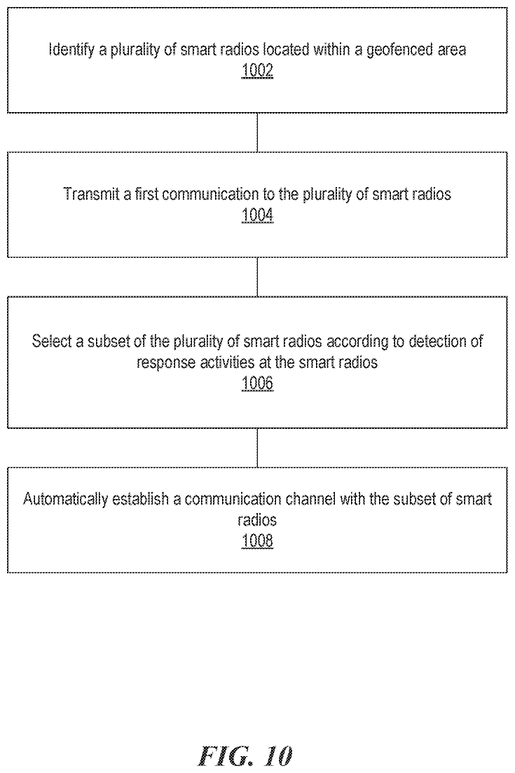

Turning now to FIG. 10, a flow diagram is provided. The flow diagram illustrates an example process for response-controlled communications for geofenced areas. In some examples, the illustrated process is performed to minimize resource usage when communicating with workers in a facility about local scenarios and events. In some embodiments, the illustrated process is performed by a cloud computing system 220 (e.g., shown in FIG. 2A). In some embodiments, the illustrated process is performed by a computer system, for example, the example computer system 1500 illustrated and described in more detail with reference to FIG. 15. Particular entities, for example, the smart radios (e.g., smart radios 905, smart radios 224), perform some or all of the steps of the process in some embodiments. Likewise, some embodiments include different and/or additional steps, or perform the steps in different orders.

In step 1002, a plurality of smart apparatuses (e.g., smart radios 905, smart radios 224) located within a geofenced area are identified. In some embodiments, the smart apparatuses are identified based on obtaining location and time logging information from multiple smart apparatuses. Locations of the multiple apparatuses are mapped to a plurality of geofences that define areas within a worksite, such as the example geofenced areas illustrated in FIG. 9.

In some embodiments, step 1002 is performed in response to a selection or an indication of the geofenced area. In an example, a geofenced area relevant to a detected event or scenario is automatically identified and used to identify the plurality of smart apparatuses.

In step 1004, a first communication is transmitted to the plurality of smart apparatuses that are identified as being located within the geofenced area. In some embodiments, the first communication is a text-based alert or notification of an event or scenario that is relevant and specific to the geofenced area. In some embodiments, the first communication is an audio-based and/or video-based message that is broadcast to the plurality of smart apparatuses.

In an example, the first communication is broadcast to workers associated with the plurality of smart apparatuses via local infrastructure located in the geofenced area, such as intercoms, alarms, video screens or billboard-like structures, and/or the like.

In step 1006, a subset of the plurality of smart radios is selected. In some embodiments, the subset of smart radios is selected according to the detection of response activities at the smart radios and according to response times based on the detection of response activities. Accordingly, the subset of smart radios constitutes a first responder audience. The subset of smart radios represents a subset of workers who responded to the initial communication in a manner that satisfies various constraints or thresholds.

For example, the subset of smart radios is selected according to a response time threshold. Smart radios at which a response activity is detected before the response time threshold are selected for the subset. As another example, the smart radios are ordered according to respective times at which response activities are detected. A first number of first radios in the order are selected for the subset.

In some embodiments, additional constraints or thresholds are considered when selecting the subset of smart radios. For example, smart radios are assigned to different workers with different roles, role levels, profiles, and/or the like. Smart radios whose assigned worker satisfies a threshold role level, a role/profile requirement, and/or the like are considered for the selection of the subset. In some embodiments, the additional constraints (e.g., threshold role level, role requirement) are determined based on the relevant event or scenario that prompted the process.

In step 1008, a communication channel with the subset of smart radios is automatically established. In some embodiments, the communication channel is established between the subset of smart radios and the computer system performing the process, such as an administrator computer system. In some embodiments, the communication channel is established between the subset of the smart radios and an administrator smart radio. In some embodiments, the communication channel is established between the smart radios of the subset to enable the local workers to coordinate the handling of and response to the relevant event or scenario. In some embodiments, the communication channel is a video call, an audio call, a text conversation, and/or the like.

In some embodiments, the determined response times used to select the subset of smart radios are added to experience profiles of workers associated with the smart radios. For example, an average response time that a worker takes to read or interact with a communication via a smart radio is stored in an experience profile for the worker.

As such, in some embodiments, selection of smart radios is further based on experience profiles of the workers associated with the smart radios. For example, workers with an average response time less than a threshold are automatically selected for the first responder subset. Use of response time metrics in worker experience profiles conserves some time that would be spent detecting response activities on the smart radios and determining (and ordering) response times.

### Smart Radio Location Displays

Embodiments described herein relate to temporally-dynamic visualization of smart radio locations within a worksite. According to example embodiments, a user interface is configured to display a slice or snapshot of smart radio locations, with multiple different slices or snapshots being available for display. Thus, embodiments for temporally-dynamic visualization of smart radio locations enable a user to easily view different locations and arrangements of smart radios over time.

In some embodiments, the user interface is provided via a smart radio (e.g., via a display screen 130 of a smart radio as illustrated and described in relation with FIG. 1). In some embodiments, the user interface is provided via a computer system as in the example computer system 1500 illustrated and described in more detail with reference to FIG. 15.

### Equipment Location Monitoring

Embodiments described herein relate to mobile equipment tracking via smart radios as triangulation references. In this context, mobile equipment refers to work site or facility industrial equipment (e.g., heavy machinery, precision tools, construction vehicles). According to example embodiments, a location of a mobile equipment is continuously monitored based on repeated triangulation from multiple smart radios located near the mobile equipment. Improvements to the operation and usage of the mobile equipment are made based on analyzing the locations of the mobile equipment throughout a facility or worksite. Locations of the mobile equipment are reported to owners of the mobile equipment, or entities that own, operate, and/or maintain the mobile equipment. Mobile equipment whose location is tracked include vehicles, tools used and shared by workers in different facility locations, tool kits and toolboxes, manufactured and/or packaged products, and/or the like. Generally, mobile equipment is movable between different locations within the facility or worksite at different points in time.

In some embodiments, a tag device is physically attached to a mobile equipment so that the location of the mobile equipment is monitored. A computer system (e.g., example computer system 1500, cloud computing system 220, a smart radio, an administrator smart radio) receives tag detection data from at least three smart radios based on the smart radios communicating with the tag device. Each instance of tag detection data received from a smart radio includes a distance to the tag device and a location of the smart radio.

In some embodiments, the tag detection data is received from smart radios owned or associated with different entities. That is, different smart radios that are not necessarily associated with the same given entity (e.g., a company with which various operators at the worksite are employed) as a given mobile equipment are used to track the given mobile equipment. As such, ubiquity of smart radios that are capable or allowed to track a given mobile equipment (via the tag device) is increased regardless of ownership or association with particular entities.

In some embodiments, the tag device is an AirTag™ device. In some embodiments, the tag device is associated with a detection range. The tag device is detectable via wireless communication by other devices, including smart radios, located within the detection range of the tag device. For example, a smart radio detects the tag device via Wi-Fi, Bluetooth, Bluetooth Low Energy, near-field communications, cellular communications, and/or the like. In some embodiments, a smart radio that is located within the detection range of the tag device detects the tag device, determines a distance between the smart radio and the tag device, and provides the tag detection data to the computer system.

From the tag detection data, the computer system determines a location of the tag device, which is representative of the location of the mobile equipment. In particular, the location of the mobile equipment is triangulated from the known locations of multiple smart radios and the respective distances to the tag device, using the tag detection data.

Thus, the computer system determines the location of the mobile equipment and is configured to continuously monitor the location of the mobile equipment as additional tag detection data is obtained over time.

In some embodiments, the determined location of the mobile equipment is indicated to the entity with which the mobile equipment is associated (e.g., an owner, a user of the mobile equipment, etc.). As discussed, in some examples, the location of the mobile equipment is determined based on triangulation of the tag device by different smart radios owned by different entities. If a mobile equipment location is determined via multiple entities, the mobile equipment location is only reported to the relevant entity, such that mobile equipment locations are not insecurely shared across entities.

In some embodiments, mobile equipment location is determined and tracked according to privacy layers or groups that are defined. For example, a tag for a mobile equipment is detected and tracked by a first group of entities (or smart radios assigned to a first privacy layer), and the determined location is reported to a smaller group of entities (or devices assigned to a second privacy layer).

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels are indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. For example, in a medical emergency situation, a particular vehicle is recommended and indicated to a nearby worker based on a monitored location for the particular vehicle being located nearest to the worker. As another example, for a worker assigned with a maintenance task at a location within a facility, one or more maintenance tool kits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations. In some embodiments, guests are handed BLE tags rather than smart radios to keep track of them in a similar manner as equipment.

### Area-Based Productivity Tracking

According to example embodiments, smart radios are assigned to different workers who are associated with different roles. For example, a first smart radio is assigned to and used by an administrator, a second smart radio is assigned to and used by a medic, and a third smart radio is assigned to and used by a maintenance technician.

The different roles associated with different workers are representative of different operations and tasks performed by the workers, which are more relevant to certain areas within a facility than other areas. As such, in some embodiments, certain geofenced areas of a facility are identified as activity areas for a given role, and different roles have different activity areas. For example, a break or rest area is an activity area for a medic but is not an activity area for a technician. As another example, a base or office area is an activity area for an administrator but is not an activity area for a vehicle operator.

That is, in some embodiments, activity areas are identified for a worker role based on an expectation that the tasks associated with the worker role are productively performed within the activity areas. Thus, a worker is expected to have an increased productivity while located within the activity area than while located outside of the activity area.

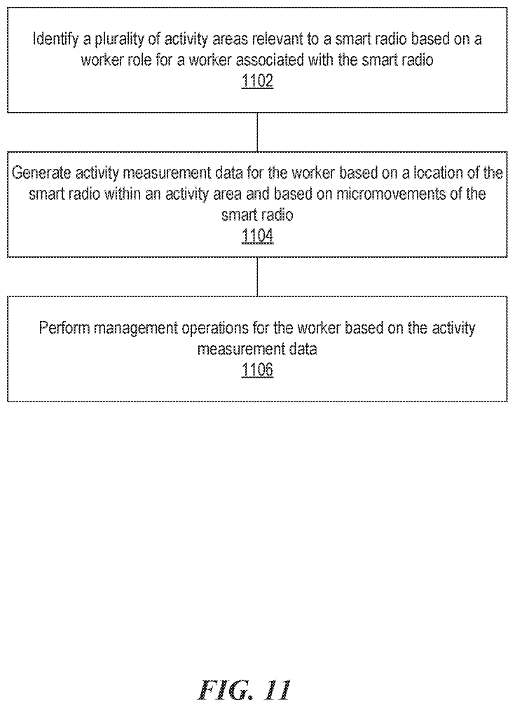

Embodiments described herein use role-specific activity areas and geofencing to classify activity levels for workers. FIG. 11 provides a flow diagram that illustrates an example process for classifying worker activity based on smart radio locations with role-specific activity areas. In some embodiments, the illustrated process is performed by a cloud computing system 220 (e.g., shown in FIG. 2A). In some embodiments, the illustrated process is performed using a long range transmission mesh network, for example, the long range transmission mesh network described in more detail with reference to FIG. 8. In some embodiments, the illustrated process is performed by a computer system, for example, the example computer system 1500 illustrated and described in more detail with reference to FIG. 15. Particular entities, for example, the smart radios (e.g., smart radios 905, smart radios 224), perform some or all of the steps of the process in some embodiments. Likewise, some embodiments include different and/or additional steps, or perform the steps in different orders.

In step 1102, a plurality of activity areas relevant to a smart radio are identified. The activity areas are geofenced areas that are mapped to a worker role of a worker who is currently using the smart radio and/or assigned to the smart radio. In some examples, metadata generated with a definition of a geofence includes an indication of worker roles for which the geofence is an activity area.

In step 1104, activity measurement data is generated. In some embodiments, the activity measurement data describes an activity or productivity level of a worker, or an estimation of whether the worker is actively performing assigned tasks.

For example, the activity measurement data includes a first activity level determined for the worker based on the smart radio (and the worker) being located within an activity area for the worker's role. The first activity level is indicative of increased productivity of the worker due to the worker being located within an activity area where the assigned tasks are intended to be performed.

In some examples, the activity measurement data includes a second activity level for the worker that is determined based on micromovements of the smart radio. For example, a relatively high degree of micromovements of the smart radio is indicative of the worker actively performing a physical task, while a relatively low degree of micromovements of the smart radio suggests that the worker is static. Thus, further to the worker being located within an activity area, physical activity of the worker is estimated and used to classify a further activity or productivity level of the worker.

In some embodiments, micromovements refer to small-scale changes in location of the smart radio, or movements that do not exceed a threshold distance within a certain time. For example, some example micromovements are detected and measured via a position tracking component of a smart radio (e.g., position tracking component 125 in FIG. 1). In some embodiments, micromovements include changes in three-dimensional position of the smart radio, for example, changes detected by a gyroscope, accelerometer, and/or similar sensors in the smart radio. Generally, from data collected at the smart radio, a degree of micromovement of the smart radio is determined and used to classify a second activity level for the worker.

In some embodiments, the activity measurement data is time-dependent and includes times at which a first activity level is classified for the worker, times at which a second activity level is classified for the worker, and/or the like.

In step 1106, management operations of the worker are performed based on the activity measurement data. In some embodiments, clock-ins of the worker are captured based on the activity measurement data including a first activity level or a second activity level for the worker. In some embodiments, time data that includes lengths of time that the worker spends at the first activity level and/or the second activity level is determined from the activity measurement data. In some embodiments, the time data is automatically provided to HR software and systems, such that manual input of the time records by the worker is not needed. In some embodiments, the time data is stored with profiles associated with the worker, such as an experience profile.

In some embodiments the activity measurement data is provided to a host server to map the locations of wireless devices (e.g., smart radios) for purposes of improving mesh connectivity for a long range transmission mesh network (e.g., the long range transmission mesh network described in FIG. 8). For example, the host server processes activity measurement data, such as the micromovements of wireless devices, to identify an approximate range between wireless devices or and/or an approximate position of wireless devices that operate as nodes on the mesh network (e.g., the wireless devices described in FIG. 8). In some embodiments, the host server provides the approximate range and position information to the wireless devices, which use the approximate range and position information to shift to frequency bands associated with a first transceiver or frequency bands associated with a second transceiver (e.g., the first and second transceivers described in FIG. 8).

In some embodiments, the activity measurement data is used to monitor exposure of the worker to hazardous conditions. For example, from the activity measurement data, a length of time that the worker is physically active in certain conditions (e.g., excessive sunlight, an oxygen-depleted environment, a room with a cold temperature) is monitored and compared against safety thresholds. Thus, in some examples, worker activity is measured and used to improve worker safety.

In some embodiments, an automated alert is transmitted to a given worker that has spent less than a threshold length of time in an activity area or has spent longer than a threshold length of time outside of an activity area. For example, a length of time that a worker is not classified at either a first activity level or a second activity level is monitored and compared against a threshold to determine whether to transmit an alert to the smart radio for the worker.

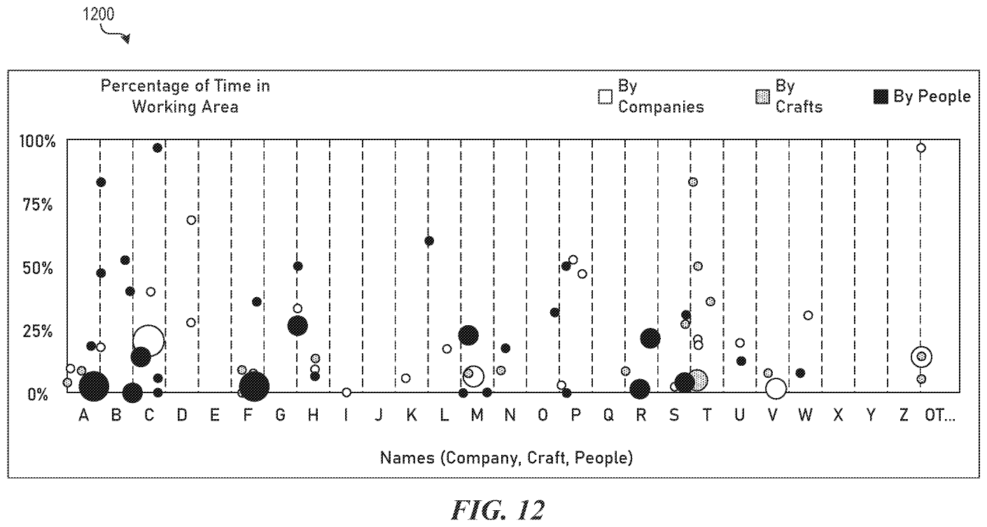

In some embodiments, the management operations includes generating a worker activity user interface for display. FIG. 12 illustrates an example worker activity user interface 1200.

In some embodiments, the worker activity user interface 1200 is provided for display at an example computer system 1500, and in particular, at a video display thereof. In some embodiments, the example computer system 1500 is an administrator system, and the worker activity user interface 1200 is provided for display to an administrator. In some embodiments, the example computer system 1500 is a smart radio, and the worker activity user interface 1200 is provided for display via a display screen 130 of the smart radio.

As illustrated in FIG. 12, the worker activity user interface 1200 is configured to indicate the activity measurement data. In some embodiments, the worker activity user interface 1200 includes a graph of percentage of time in an activity area. For example, a data point associated with a given worker is located on the graph to represent a percentage of total time that the given worker is located within an activity area for the given worker's role. In FIG. 12, multiple data points are located on the graph and shown as circles of varying sizes. The respective size of a circle indicates a number of data points that overlap.

That is, in some embodiments, the worker activity user interface 1200 indicates a length of time that each worker is classified with a first activity level. In some embodiments, the worker activity user interface 1200 additionally or alternatively indicates a length of time that each worker is classified with a second activity level or is exhibiting threshold physical micromovements within an activity area.

In some embodiments, as illustrated in FIG. 12, worker-specific activity measurement data is aggregated based on groupings of workers. Accordingly, in some embodiments, an average length of time that a group of workers are classified with a first activity level and/or classified with a second activity level is indicated in the worker activity user interface 1200. For example, workers are grouped by affiliation with certain entities (e.g., by company), by worker roles (e.g., crafts), and/or the like.

It will be appreciated that the worker activity user interface 1200 includes other indications of the activity measurement data, in some examples. For example, a ranked list or leaderboard of workers (or groups thereof) that is sorted by lengths of time at a first activity level is displayed via the worker activity user interface 1200.

In some embodiments, the worker activity interface is focused on predetermined slices of time. For example, after a worksite evacuation and a return-to-work order has been issued, the activity monitor identifies how long each worker, and each set of workers associated with a given subset of workers (e.g., those associated with a particular subcontractor). The example uses both geofencing to identify how long it takes for those workers to return to the designated work site geofence for those workers and/or exhibiting threshold physical micromovements and/or within range of BLE tagged equipment (see above disclosure relating to equipment experience tacking).

The slice of time observed is based on a time stamp of a worksite evacuation order and bounded by the time the tracked last worker returns to work. The dashboard then indicates to administrators' which workers respond to return-to-work orders most efficiently.

### Roaming Channels

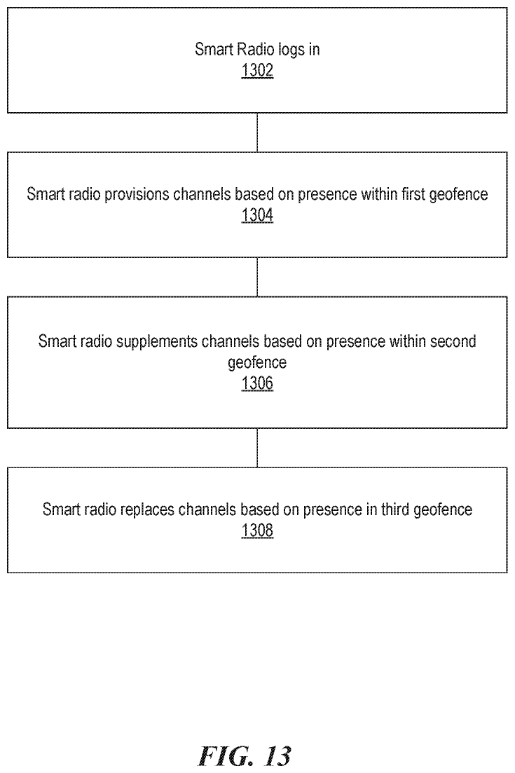

The smart radio is further configured to roam channels based on presence within a geofence. FIG. 13 is a flowchart illustrating automatic roaming of channels. As described above, an administrative user assigns users to particular teams, jobs, or facilities and the user's smart radio channels are determined therefrom. However, in some embodiments, a greater number of channels are derived from the geofence that the user (e.g., and the smart radio they are logged into) is present in. In step 1302, when a user logs into a smart radio using the global directory/tap & go, the user is present within a given geofence. In step 1304, the geofence the user is present in triggers provisioning of their smart radio to the employer, job, and teams of most associated with that geofence.

For example, although an administrative user is able to manually assign users to associated or assigned groups, a user using their own preconfigured geofence allows for less steps required for managing individual users that may be largely transient. Where users login, a first geofence provisions their device with some channels (e.g., associated the user with the employer for the day). In step 1306, the user is then instructed to go to a second location where a second geofence further provisions the smart radio for the day (e.g., associating the user with a given facility/job for the day).

In step 1308, where the user is subsequently directed to a third location, a third geofence revises the prior provisioning of the smart radio associated with the user's profile. Revisions to the user's current operation modify the radio channels available to the user on the smart radio. The changes to the available channels are an automatic and seamless process for the user.

### Computer Embodiment

FIG. 14 is a block diagram illustrating an example ML system 1400, in accordance with one or more embodiments. The ML system 1400 is implemented using components of the example computer system 1500 illustrated and described in more detail with reference to FIG. 15. For example, portions of the ML system 1400 are implemented on the apparatus 100 illustrated and described in more detail with reference to FIG. 1, or on the cloud computing system 220 illustrated and described in more detail with reference to FIGS. 2A and 2B. Likewise, different embodiments of the ML system 1400 include different and/or additional components and are connected in different ways. The ML system 1400 is sometimes referred to as a ML module.

The ML system 1400 includes a feature extraction module 1408 implemented using components of the example computer system 1500 illustrated and described in more detail with reference to FIG. 15. In some embodiments, the feature extraction module 1408 extracts a feature vector 1412 from input data 1404. For example, the input data 1404 includes location parameters measured by device implemented in accordance with the architecture 100 illustrated and described in more detail with reference to FIG. 1. The feature vector 1412 includes features 1412a, 1412b, . . . , 1412n. The feature extraction module 1408 reduces the redundancy in the input data 1404, for example, repetitive data values, to transform the input data 1404 into the reduced set of features 1412, for example, features 1412a, 1412b, . . . , 1412n. The feature vector 1412 contains the relevant information from the input data 1404, such that events or data value thresholds of interest are identified by the ML model 1416 by using a reduced representation. In some example embodiments, the following dimensionality reduction techniques are used by the feature extraction module 1408: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 1416 performs deep learning (also known as deep structured learning or hierarchical learning) directly on the input data 1404 to learn data representations, as opposed to using task-specific algorithms. In deep learning, no explicit feature extraction is performed; the features 1412 are implicitly extracted by the ML system 1400. For example, the ML model 1416 uses a cascade of multiple layers of nonlinear processing units for implicit feature extraction and transformation. Each successive layer uses the output from the previous layer as input. The ML model 1416 thus learns in supervised (e.g., classification) and/or unsupervised (e.g., pattern analysis) modes. The ML model 1416 learns multiple levels of representations that correspond to different levels of abstraction, wherein the different levels form a hierarchy of concepts. The multiple levels of representation configure the ML model 1416 to differentiate features of interest from background features.

In alternative example embodiments, the ML model 1416, for example, in the form of a CNN generates the output 1424, without the need for feature extraction, directly from the input data 1404. The output 1424 is provided to the computer device 1428, the cloud computing system 220, or the apparatus 100. The computer device 1428 is a server, computer, tablet, smartphone, smart speaker, etc., implemented using components of the example computer system 1500 illustrated and described in more detail with reference to FIG. 15. In some embodiments, the steps performed by the ML system 1400 are stored in memory on the computer device 1428 for execution. In other embodiments, the output 1424 is displayed on the apparatus 100 or electronic displays of the cloud computing system 220.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 1416 is a CNN that includes both convolutional layers and max pooling layers. For example, the architecture of the ML model 1416 is “fully convolutional,” which means that variable sized sensor data vectors are fed into it. For convolutional layers, the ML model 1416 specifies a kernel size, a stride of the convolution, and an amount of zero padding applied to the input of that layer. For the pooling layers, the model 1416 specifies the kernel size and stride of the pooling.

In some embodiments, the ML system 1400 trains the ML model 1416, based on the training data 1420, to correlate the feature vector 1412 to expected outputs in the training data 1420. As part of the training of the ML model 1416, the ML system 1400 forms a training set of features and training labels by identifying a positive training set of features that have been determined to have a desired property in question, and, in some embodiments, forms a negative training set of features that lack the property in question.

The ML system 1400 applies ML techniques to train the ML model 1416, that when applied to the feature vector 1412, outputs indications of whether the feature vector 1412 has an associated desired property or properties, such as a probability that the feature vector 1412 has a particular Boolean property, or an estimated value of a scalar property. In embodiments, the ML system 1400 further applies dimensionality reduction (e.g., via linear discriminant analysis (LDA), PCA, or the like) to reduce the amount of data in the feature vector 1412 to a smaller, more representative set of data.

In embodiments, the ML system 1400 uses supervised ML to train the ML model 1416, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 1432 is formed of additional features, other than those in the training data 1420, which have already been determined to have or to lack the property in question. The ML system 1400 applies the trained ML model 1416 to the features of the validation set 1432 to quantify the accuracy of the ML model 1416. Common metrics applied in accuracy measurement include Precision and Recall, where Precision refers to a number of results the ML model 1416 correctly predicted out of the total it predicted, and Recall is a number of results the ML model 1416 correctly predicted out of the total number of features that had the desired property in question. In some embodiments, the ML system 1400 iteratively re-trains the ML model 1416 until the occurrence of a stopping condition, such as the accuracy measurement indication that the ML model 1416 is sufficiently accurate, or a number of training rounds having taken place. In embodiments, the validation set 1432 includes data corresponding to confirmed locations, dates, times, activities, or combinations thereof. This allows the detected values to be validated using the validation set 1432. The validation set 1432 is generated based on the analysis to be performed.

FIG. 15 is a block diagram illustrating an example computer system, in accordance with one or more embodiments. Components of the example computer system 1500 are used to implement the smart radios 224, the cloud computing system 220, and the smart camera 236 illustrated and described in more detail with reference to FIGS. 2A and 2B. In some embodiments, components of the example computer system 1500 are used to implement the ML system 200 illustrated and described in more detail with reference to FIGS. 2A and 2B. At least some operations described herein are implemented on the computer system 1500.

The computer system 1500 includes one or more central processing units (“processors”) 1502, main memory 1506, non-volatile memory 1510, network adapters 1512 (e.g., network interface), video displays 1518, input/output devices 1520, control devices 1522 (e.g., keyboard and pointing devices), drive units 1524 including a storage medium 1526, and a signal generation device 1520 that are communicatively connected to a bus 1516. The bus 1516 is illustrated as an abstraction that represents one or more physical buses and/or point-to-point connections that are connected by appropriate bridges, adapters, or controllers. In embodiments, the bus 1516, includes a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

In embodiments, the computer system 1500 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1500.

While the main memory 1506, non-volatile memory 1510, and storage medium 1526 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1528. The term “machine-readable medium” and “storage medium” shall also be taken to include any medium that is capable of storing, encoding, or carrying a set of instructions for execution by the computer system 1500.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 1504, 1508, 1528) set at various times in various memory and storage devices in a computer device. When read and executed by the one or more processors 1502, the instruction(s) cause the computer system 1500 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1510, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1512 enables the computer system 1500 to mediate data in a network 1514 with an entity that is external to the computer system 1500 through any communication protocol supported by the computer system 1500 and the external entity. In embodiments, the network adapter 1512 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 1512 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. One will recognize that “memory” is one form of a “storage” and that the terms are on occasion used interchangeably.

Consequently, alternative language and synonyms are used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

1. A wireless communication system comprising:
a first wireless handset including:
a first wireless communication transceiver configured to communicate via wireless and machine to machine protocols in the 2.4-2.6 GHz band; and
a second wireless communication transceiver configured to include a long range (LoRa) chip set and a Codec 2 communication protocol, and to operate in the 900 MHz band;
wherein the first wireless handset operates as a first node on a mesh network and is configured to identify an approximate range of a second node on the mesh network, wherein the first wireless handset is configured to process a header of a transmission and to broadcast the transmission, and wherein the first wireless handset automatically shifts between wireless bands associated with the first wireless transceiver and the second wireless transceiver based on the approximate range of the second node; and
a host server configured to receive, store, and communicate data with the mesh network.

2. The wireless communication system of claim 1, wherein the transmission further includes a payload, and wherein the header of the transmission further designates a target device to receive the payload.

3. The wireless communication system of claim 2, wherein the nodes of the mesh network other than the target device are configured to rebroadcast the transmission and enables hops from node to node.

4. The wireless communication system of claim 1, wherein the first wireless handset is configured to communicate the transmission to the host server via the Internet, and wherein the host server is configured to communicate the transmission to the second node.

5. The wireless communication system of claim 1, wherein the first wireless handset is further configured to downsample the transmission while broadcasting the transmission via wireless bands associated with the second wireless transceiver.

6. The wireless communication system of claim 5, wherein the second node of the mesh network is a second wireless handset, and is further configured to upsample the previously downsampled transmission while broadcasting the transmission to one or more other nodes on the mesh network via wireless bands associated with the first wireless transceiver.

7. The wireless communication system of claim 1, wherein the first wireless handset is further configured to identify the approximate range of the second node on the mesh network at least in part by periodically transmitting a range request signal to the second node.

8. The wireless communication system of claim 7, wherein the first wireless handset is further configured to triangulate an approximate position of the second node on the mesh network at least in part by processing a plurality of range request signals responded to by the second node.

9. The wireless communication system of claim 8, wherein the first wireless handset is further configured to automatically broadcast in wireless bands associated with the second wireless transceiver if the approximate range and approximate position of the second node on the mesh network are undetermined to the first wireless handset.

10. A wireless communication system comprising:
a first wireless device including:
a first transceiver configured to communicate via wireless and machine to machine protocols and operating within a first wireless band; and
a second transceiver configured to communicate via a low-bitrate protocol and operating within a second wireless band that is lower frequency than the first wireless band;
wherein the first wireless device operates as a first node on a mesh network and is configured to identify an approximate range of a second node on the mesh network, wherein the first wireless device is configured to broadcast a transmission, and wherein the first wireless device automatically shifts between wireless bands associated with the first transceiver and the second transceiver based on the approximate range of the second node; and
a host server configured to receive, store, and communicate data with the mesh network.

11. The wireless communication system of claim 10, wherein the transmission includes a header and a payload, and wherein the header of the transmission designates a target device to receive the payload.

12. The wireless communication system of claim 11, wherein the nodes of the mesh network other than the target device are configured to rebroadcast the transmission and enables hops from node to node.

13. The wireless communication system of claim 10, wherein the first wireless device is configured to communicate the transmission to the host server via the Internet, and wherein the host server is configured to communicate the transmission to the second node.

14. The wireless communication system of claim 10, wherein the first wireless device is further configured to downsample the transmission while broadcasting the transmission via wireless bands associated with the second transceiver.

15. The wireless communication system of claim 14, wherein the second node of the mesh network is a second wireless device, and is further configured to upsample the previously downsampled transmission while broadcasting the transmission to one or more other nodes on the mesh network via wireless bands associated with the first transceiver.

16. The wireless communication system of claim 10, wherein the first wireless device is further configured to identify the approximate range of the second node on the mesh network at least in part by periodically transmitting a range request signal to the second node.

17. The wireless communication system of claim 16, wherein the first wireless device is further configured to triangulate an approximate position of the second node on the mesh network at least in part by processing a plurality of range request signals responded to by the second node.

18. The wireless communication system of claim 17, wherein the first wireless device is further configured to automatically broadcast in wireless bands associated with the second transceiver if the approximate range and approximate position of the second node on the mesh network are undetermined to the first wireless device.

19. A method of using a wireless communication system comprising:
deploying a first wireless device as a first node on a mesh network, wherein the first wireless device includes:
a first transceiver configured to communicate via wireless and machine to machine protocols and operating in a first wireless band; and
a second transceiver configured to communicate via a low-bitrate protocol and operating within a second wireless band that is lower frequency than the first wireless band;
identifying an approximate range of a second node on the mesh network by the first wireless device;
shifting automatically between wireless bands associated with the first transceiver and the second transceiver by the first wireless device based on the approximate range of the second node;
processing a header of a transmission by the first wireless device;
broadcasting the transmission to the second node by the first wireless device; and
communicating, by the first wireless device, with a host server configured to receive, store, and communicate data with the mesh network.

20. The method of claim 19, wherein the transmission further includes a payload, and wherein the header of the transmission further designates a target device to receive the payload.

21. The method of claim 20, wherein the nodes of the mesh network other than the target device are configured to rebroadcast the transmission and enables hops from node to node.

22. The method of claim 19, further comprising:
transmitting the transmission to the host server via the Internet, wherein the host server is configured to communicate the transmission to the second node.

23. The method of claim 19, wherein the first wireless device is further configured to downsample the transmission while broadcasting the transmission via wireless bands associated with the second transceiver.

24. The method of claim 23, wherein the second node of the mesh network is a second wireless device, and is further configured to upsample the previously downsampled transmission while broadcasting the transmission to one or more other nodes on the mesh network via wireless bands associated with the first transceiver.

25. The method of claim 19, wherein the first wireless device is further configured to identify the approximate range of the second node on the mesh network at least in part by periodically transmitting a range request signal to the second node.
